(19) United States
(12) Patent Application Publication
(10) Pub. No.: US 2005/0212302 A1
(43) Pub. Date: Sep. 29, 2005

(54) Latch

(76) Inventor: Sidney Edward Fisher, Redditch (GB)

Correspondence Address: CARLSON, GASKEY & OLDS, P.C., 400 WEST MAPLE ROAD, SUITE 350, BIRMINGHAM, MI, 48009, US

(21) Appl. No.: 11/080,342

(22) Filed: Mar. 15, 2005

(30) Foreign Application Priority Data
Mar. 24, 2004 (GB) 0406553.8

(51) Int. Cl. E05C 3/06

(52) U.S. Cl. 292/216

(57) ABSTRACT

A latch includes a latch bolt having a closed position and an open position, a pawl having an engaged position wherein the pawl retains the latch bolt in the closed position and a released position wherein the pawl allows the latch bolt to move from the closed position, and an energy storage device. The latch further includes a first drive path operable to couple the energy storage device to the pawl such that the energy storage device acts by releasing energy to assist movement of the pawl from the engaged position to the released position. The latch also includes a second drive path operable to couple the latch bolt to the energy storage device such that during at least a part of the movement of the latch bolt from the closed position to the open position, the latch bolt acts to restore the energy in the energy storage device.

### REFERENCE TO RELATED APPLICATION

This application claims priority to United Kingdom patent application GB 0406553.8 filed Mar. 24, 2004.

### BACKGROUND OF THE INVENTION

The present invention relates generally to latches, and in particular to latches for use in vehicles, such as trucks and cars, and to closures of vehicles, such as passenger or driver doors, bonnets, boots and the like.

Latches including a latch mechanism mounted on a vehicle door and a latch striker mounted on a fixed structure of a vehicle e.g., a part of an aperture within which a door sits, are known. The latch mechanism includes a rotating claw which can be held in a closed position by a pawl. When in the closed position, the claw retains the striker, thereby preventing the door from opening. To open the door, the pawl has to be disengaged from the claw, thereby freeing the claw to move to the open position whereupon the striker is released and the door can be fully opened.

When in a closed position, a pawl tooth engages an abutment of the claw, and the claw is released when the pawl tooth is disengaged from the abutment. To release the claw, the pawl tooth is slid across the claw abutment, generating friction during this sliding movement.

Vehicle manufacturers must minimize noise generated by the vehicle, and in particular must minimize wind noise within the vehicle. To accomplish this, the weather seals (i.e., the seals that engage with a periphery of the door when the door is closed) are designed with increasing seal loads. By increasing the weather seal load, the force required to release the pawl from the claw increases since the friction force between the pawl tooth and claw abutment is increased. When the latch is manually opened, a higher manual force is required to be applied to the door handle. When the latch can be power opened (i.e., can be opened by operation of the power actuator), then the actuator needs to be more powerful to overcome the increased friction level.

### SUMMARY OF THE INVENTION

An object of the present invention is to provide a latch which can be released with a lower actuating force.

Thus, the present invention provides a latch includes a latch bolt having a closed position and an open position. The latch also includes a pawl having an engaged position wherein the pawl retains the latch bolt in the closed position and a released position wherein the pawl allows the latch bolt to move from the closed position and an energy storage device. The latch further includes a first drive path operable to couple the energy storage device to the pawl such that the energy storage device acts by releasing energy to assist movement of the pawl from the engaged position to the released position. The latch also includes a second drive path operable to couple the latch bolt to the energy storage device such that during at least a part of the movement of the latch bolt from the closed position to the open position, the latch bolt acts to restore the energy in the energy storage device.

The energy storage device is retained in a rest position by a detent. The second drive path includes the pawl, and the first drive path is blocked to lock the latch.

Further features and advantages of the invention will become more clear from the detailed description that follows of some embodiments of the invention given solely by way of example and with reference to the attached drawings.

### BRIEF DESCRIPTION OF THE DRAWINGS

The invention will now be described, by way of example only, with reference to the drawings in which:

FIGS. 1A1 to 1E show a first embodiment of a latch according to the present invention;

FIGS. 2A1 to 2E show a second embodiment of the latch according to the present invention;

FIGS. 3A1 to 3E show a third embodiment of the latch according to the present invention;

FIGS. 4A1 to 4C4 show a fourth embodiment of the latch according to the present invention;

FIGS. 5A1 to 5E show a fifth embodiment of the latch according to the present invention;

FIGS. 6A1 to 6D show a sixth embodiment of the latch according to the present invention;

FIGS. 7A1 to 7A4 show a seventh embodiment of the latch according to the present invention;

FIGS. 8A1 to 8D show an eighth embodiment of the latch according to the present invention;

FIGS. 9A1 to 9D show a ninth embodiment of the latch according to the present invention;

FIGS. 10A1 to 10C4 show a tenth embodiment of the latch according to the present invention; and

FIGS. 11A1 to 11C4 show an eleventh embodiment of the latch assembly according to the present invention.

### DETAILED DESCRIPTION OF THE PREFERRED EMBODIMENT

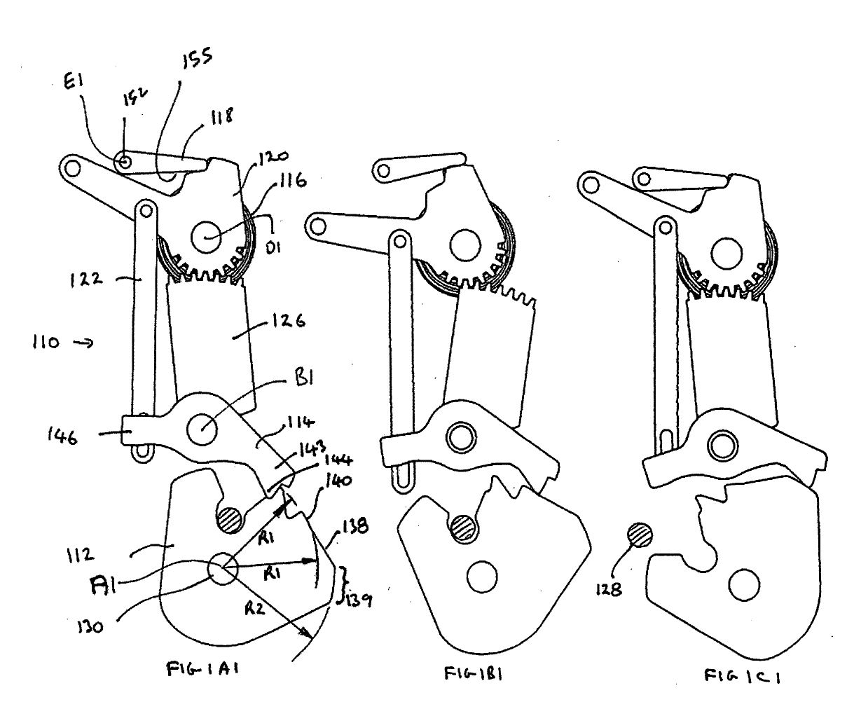

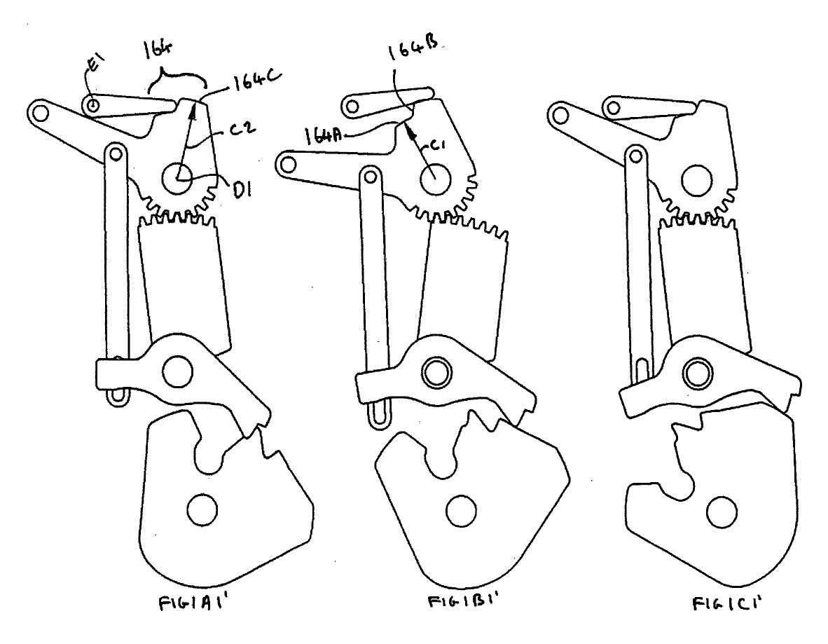

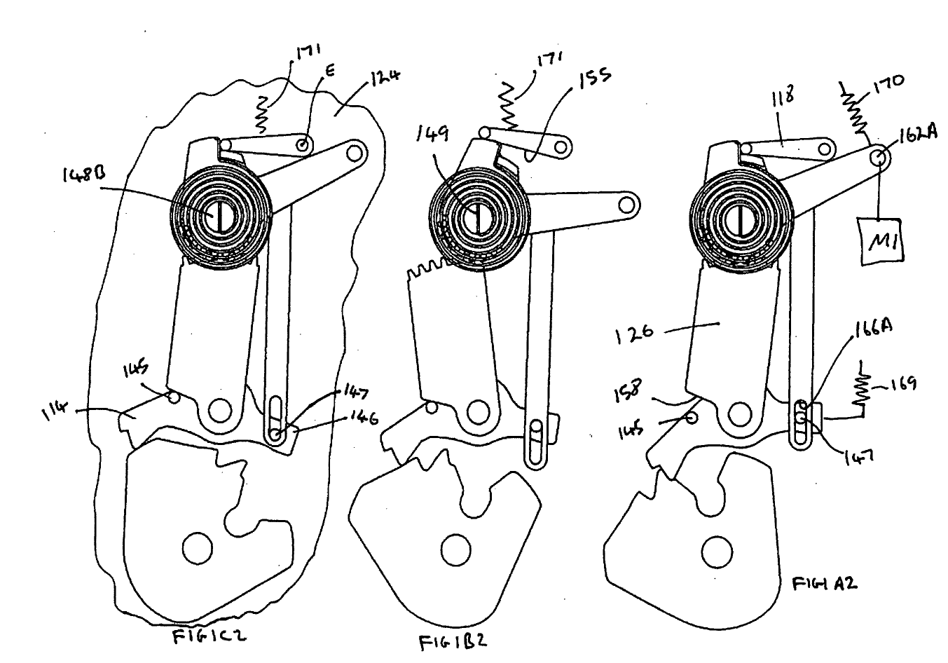

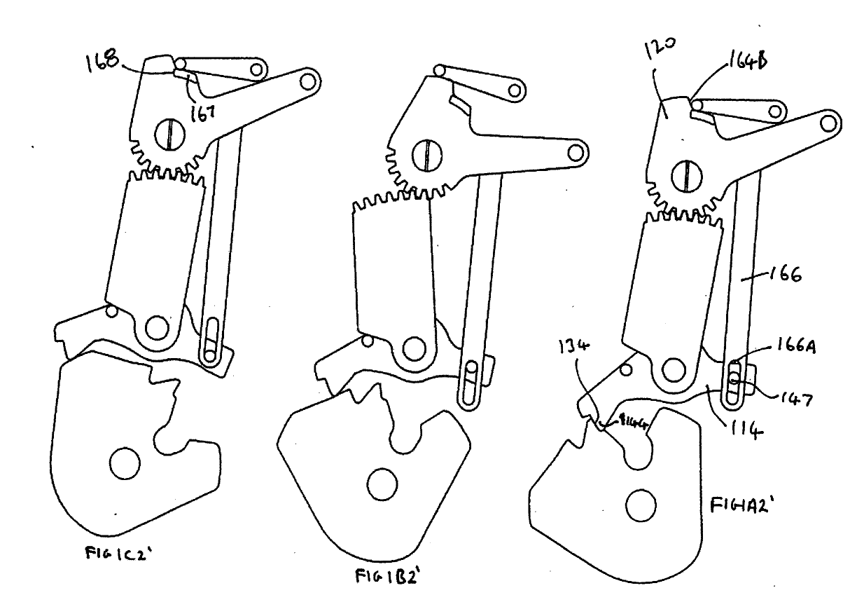

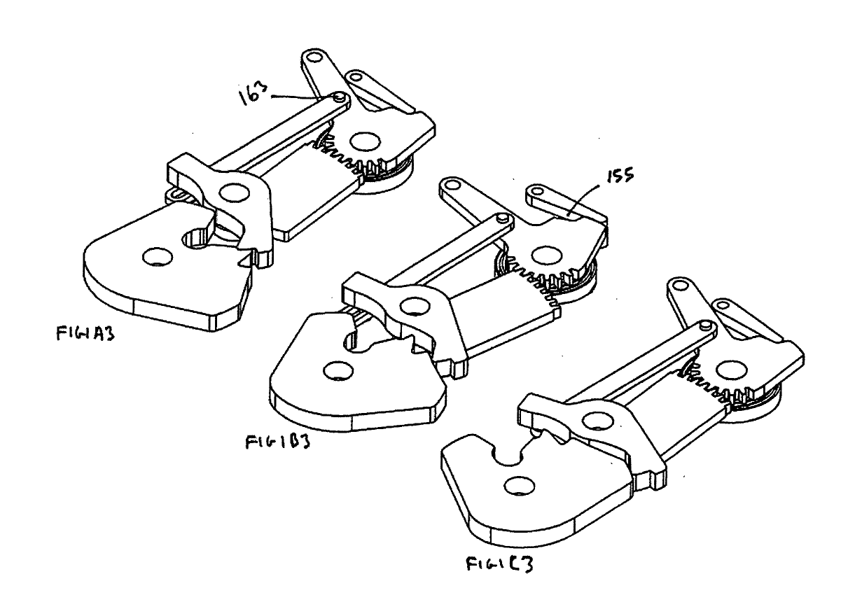

FIGS. 1A to 1E show a latch assembly 110 including a latch bolt in the form of a rotating claw 112, a pawl 114, an energy storage device in the form of a spiral spring 116, a detent 118, a drive plate 120, a link 122 and a gear 126. The latch assembly 110 further includes a latch body 124 shown schematically in FIG. 1C2.

FIGS. 1A1, 1B1 and 1C1 show a striker 128 which is releasably retainable by the latch assembly 110. Typically, the striker 128 will be positioned on a fixed structure of a vehicle.

As shown in FIGS. 1A1, 1D and 1E, the latch claw 112 includes a hole 130 to enable the claw 112 to be pivotally mounted about an axis A1 on a claw pivot pin (not shown), which is secured to the latch body 124. The claw 112 includes a mouth 132 which releasably receives the striker 128. A closed abutment 134 and a first safety abutment 136 are provided on a periphery of the claw 112. The radially outermost portion of the closed abutment 134 and the first safety abutment 136 are both positioned at a radius R1 relative to the axis A1.

A portion 139 of the periphery of the claw 112 is positioned at a radius R2 relative to the axis A1. FIG. 1A1 shows that the radius R2 is greater than the radius R1, and a ramp portion 138 connects the portion 139 to a further portion 140 which is located at the radius R1.

A pawl 114 includes a central hole 142 to rotatably mount the pawl 114 about an axis B1 on a pawl pivot pin (not shown), which in turn is secured to the latch body 124. The pawl 114 includes a first arm 143 which includes a pawl tooth 144 and a rewind pin 145. A second arm 146 includes a pawl release pin 147.

A drive plate pivot pin 148 is provided with an end 148A connected rotationally fast with the latch body 124. An end 148B includes a diametrically orientated slot 149. The drive plate pivot pin 148 is generally cylindrical and defines an axis D1.

The spiral spring 116 includes a radially inner end 150 and a radially outer end 151. The spiral spring 116 includes several spring turns.

The detent 118 includes a hole 152 to pivotally mount the detent 118 about an axis E1 on a pivot pin (not shown), which in turn is secured to the latch body 124. An end 118A of the detent 118 includes a camming abutment 153 and a spring abutment 154. The detent 118 is generally elongate and includes an edge 155.

A gear 126 includes a hole 156 for pivotally mounting the gear 126 about the axis B1 on the pawl pivot pin to allow the gear 126 to rotate relative to the latch body 124. The gear 126 includes gear teeth 157 and a rewind abutment 158.

A drive plate 120 includes a hole 160 that allows the drive plate 120 to be pivotally mounted about the axis D1 on the drive plate pivot pin 148 proximate the end 148A. The drive plate 120 includes gear teeth 161, a release arm 162 having a hole 162A and a release arm pin 163. The drive plate 120 is generally planar and includes a camming region 164 having a portion 164A located at radius C1 from the axis D1, a portion 164C located at a radius C2 from the axis D1, and a ramp portion 164B which connects the portions 164A and 164C. The drive plate 120 further includes a circumferentially orientated boss 167 having a spring abutment 168.

The link 122 is generally elongate and includes a hole 165 to enable the link 122 to be mounted on the release arm pin 163. The link 122 further includes an elongate slot 166 which mounts over the pawl release pin 147 of the pawl 114.

FIGS. 1A1, 1A2, 1A3, 1A4, 1A1′, 1A2′, 1A3′; 1A4′ (the “1A” figures) show the latch assembly 110 in a closed condition. Thus, the claw 112 is in a closed position such that the striker 128 is retained in the mouth 132. The claw 112 is prevented from rotating in a counter-clockwise direction (when viewing FIG. 1A1) by the engagement between the pawl tooth 144 and the closed abutment 134. The gear teeth 157 engage the gear teeth 161. The spiral spring 116 has been wound up, i.e., it is storing energy. The radially inner end 150 is engaged in the slot 149, and hence the radially inner end 150 of the spiral spring 116 cannot rotate.

The radially outer end 151 of the spiral spring 116 is biased into engagement with the spring abutment 154 of the detent 118 by virtue of the spring tension. The force applied by the spiral spring 116 on the spring abutment 154 acts generally longitudinally relative to the detent 118, and in particular acts generally through the axis E1. As such, there is no tendency for the detent 118 to rotate, and hence the detent 118 prevents the radially outer end 151 from rotating in a clockwise direction when viewing FIG. 1A2.

The spring abutment 168 of the drive plate 120 is also in engagement with the radially outer end 151 of the spiral spring 116. FIG. 1A2 shows a spring 169 (shown schematically) which is relatively light and which biases the pawl 114 in a counter-clockwise direction when viewing FIG. 1A2. A further spring 170 (shown schematically) is also relatively light and acts to bias the drive plate 120 in a counter-clockwise direction when viewing FIG. 1A2. Thus, the spring 169 ensures full engagement between the pawl tooth 144 and the closed abutment 134, and the further spring 170 ensures the spring abutment 168 of the drive plate boss 167 engages a radially inner portion of the radially outer end 151 of the spiral spring 116.

FIG. 1A2 shows that the pawl release pin 147 is spaced from an end 166A of the elongate slot 166. Furthermore, the rewind pin 145 of the pawl 114 is spaced from the rewind abutment 158 of the gear 126.

Operation of latch assembly 110 is as follows: With reference to FIG. 1A2, a manually actuable element M1 (shown schematically) is connected to the drive plate 120 via the hole 162A. When the latch assembly 110 is used on a passenger door or driver door of a car, then the manually actuable element M1 would typically be an inside door handle or an outside door handle either of which are normally used to release the latch. Actuation of the manually actuable element M1 causes the drive plate 120 to rotate clockwise, causing the ramp portion 164B (best seen in FIG. 1A2′) to engage the camming abutment 153 of the detent 118 and thereby rotate the detent 118 clockwise about the axis E1. The clockwise rotation causes the spring abutment 154 to disengage the radially outer end 151 of the spiral spring 116. Once the radially outer end 151 has been released, it rotates in a clockwise direction and re-engages the spring abutment 168 of the drive plate 120 and thereafter assists in disengaging the pawl tooth 144 from the closed abutment 134.

In particular, FIG. 1A2′ shows that there is a gap between the pawl release pin 147 and the end 166A of the slot 166. The gap is arranged to substantially close just as the detent 118 releases the spiral spring 116. In this manner, the energy stored in the spiral spring 116 is released and acts to rotate the drive plate 120 clockwise (when viewing FIG. 1A2′) and thereby drive the link 122 downwardly to rotate the pawl 114 clockwise, thereby disengaging the pawl tooth 144 from the closed abutment 134. In this manner, the spiral spring 116 assists in releasing the latch.

Once the components have reached the position shown in the “1B” Figures, the claw 112 starts to open, though the striker 128 is not completely released from the mouth 132 of the claw 112. Nevertheless, the claw 112 has rotated to such an extent that the closed abutment 134 and the first safety abutment 136 have both moved past the pawl tooth 144. Thus, the pawl 114 is incapable of preventing further opening of the claw 112. The pawl tooth 144 is resting against the further portion 140 of the claw 112. As mentioned above, the further portion 140 is positioned at the radius R1 from the axis A1. In the position shown in the “1B” Figures, the rewind pin 145 has just contacted the rewind abutment 158.

Continued opening of the door from the Figure “1B” position to the Figure “1C” position is either achieved by the door seals forcing the door open or alternatively by the user pulling or pushing the door open. Movement of the latch from the Figure “1B” position to the Figure “1C” position forces the claw 112 to rotate to release the striker 128. During release of the striker 128, the ramp portion 138 moves under the pawl tooth 144 such that the pawl tooth 144 rides up the ramp portion 138 and, as shown in the Figure “1C” position, rests on the portion 139. As mentioned above, since the portion 139 is at a radius R2 which is greater than the radius R1 of the further portion 140, the pawl 114 is caused to rotate by the claw 112. Thus, FIG. 1C2 shows that the pawl 114 has been rotated clockwise when compared to the position shown in FIG. 1B2. This clockwise rotation of the pawl 114 causes the rewind pin 145 of the pawl 114 to drive the rewind abutment 158, and hence the gear 126, clockwise when viewing FIG. 1C2. In turn, the drive plate 120 is driven counter-clockwise by virtue of meshing gear teeth 157 and 161. As the drive plate 120 rotates counter-clockwise, the spring abutment 168 engages the radially outer end 151 of the spiral spring 116, thereby rewinding the spiral spring 116. Once the radially outer end 115 achieves the position shown in FIG. 1C2, a relatively light spring 171 (shown schematically) biases the detent 118 counter-clockwise about the axis E1 such that the spring abutment 154 prevents subsequent unwinding of the spiral spring 116.

When moving from the FIG. 1A position to the FIG. 1C position, the edge 155 of the detent 118 is engaged by the portion 164C of the camming region 164. Thus, the detent 118 is held in the raised position until the radially outer end 151 of the spiral spring 116 passes under the spring abutment 154 as the spiral spring 116 is rewound. The tip 151A of the radially outer end 151 is bent over to ensure that the spring abutment 154 cannot become caught behind the radially outer end 151 during rewinding of the spiral spring 116.

A comparison of FIGS. 1A2 and 1C2 show that the drive plate 120, the detent 118, the spiral spring 116 and the gear 126 are all in the same position. However, as shown in FIG. 1A2, the pawl 114 is retaining the claw 112 in a closed position, and as shown in FIG. 1C2, the claw 112 is in a fully open position.

There is a drive path (also known as a first drive path) which includes components that allow the spiral spring 116 to assist in moving the pawl 114 to release the claw 112. There is also a further drive path (known as a second drive path) which allows movement of the claw 112 to rewind the spiral spring 116.

Thus, when the spiral spring 116 assists in releasing the latch, the radially outer end 151 of the spiral spring 116 drives the spring abutment 168 of the boss 167, which drives the drive plate 120, which drives the release arm 162, which drives the release arm pin 163, which drives the link 122 and which drives the pawl release pin 147 to release the pawl tooth 144 from the closed abutment 134 of the claw 112.

If the pawl tooth 144 is engaged with the first safety abutment 136 of the claw 112 (wherein the associated door is not fully closed, though nevertheless cannot be pulled open), the same drive path operates to release the pawl tooth 144 from the first safety abutment 136 of the claw 112.

However, the drive path which allows the spiral spring 116 to be rewound is different. Thus, the opening of the door causes the striker 128 to drive on an edge of the mouth 132 of the claw 112, which rotates the claw 112. This causes the ramp portion 138 to rotate the pawl 114 to cause the rewind pin 145 to engage the rewind abutment 158 to drive the gear teeth 157 and to drive gear teeth 161 to rotate the drive plate 120 to cause the spring abutment 168 to rewind the spiral spring 116.

Certain components are common to the first drive path and the second drive path i.e., the spring abutment 168, the drive plate 120, and the pawl 114.

However, certain components operate to disengage the pawl tooth 144 from the claw abutment, but do not operate to rewind the spiral spring 116, e.g., the release arm 162, the release arm pin 163, the link 122, the pawl release pin 147. Furthermore, certain other components operate to rewind the spiral spring 116, but do not operate to disengage the pawl tooth 144 from the claw abutment, e.g., the striker 128, the claw 112, the ramp portion 138, the pawl tooth 144, the rewind pin 145, the gear 126, and the gear teeth 161.

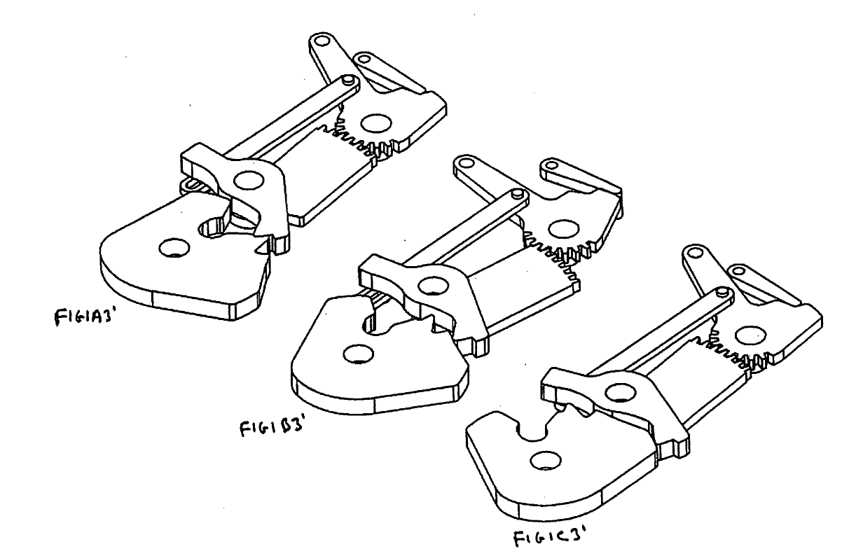

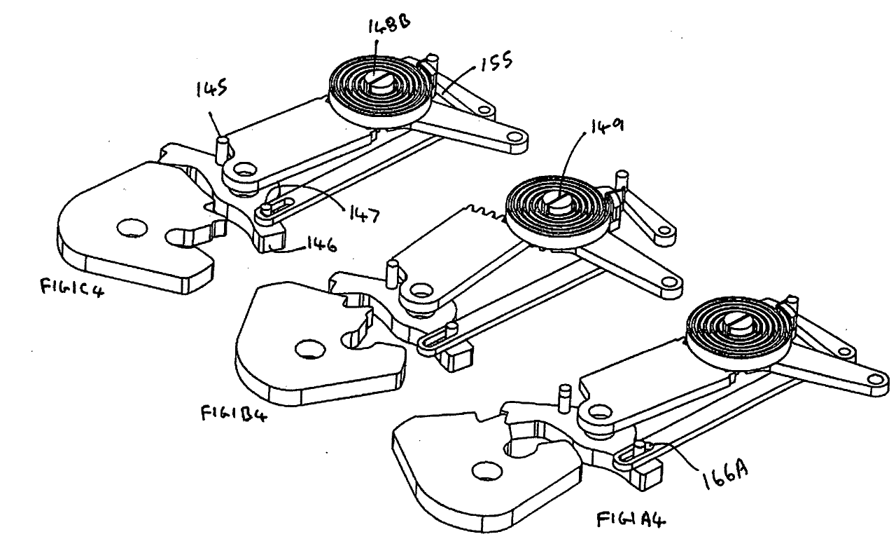

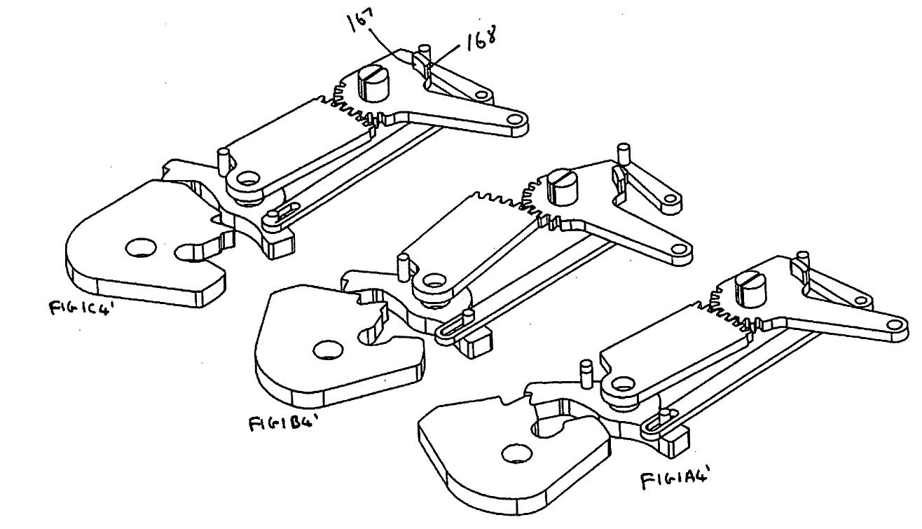

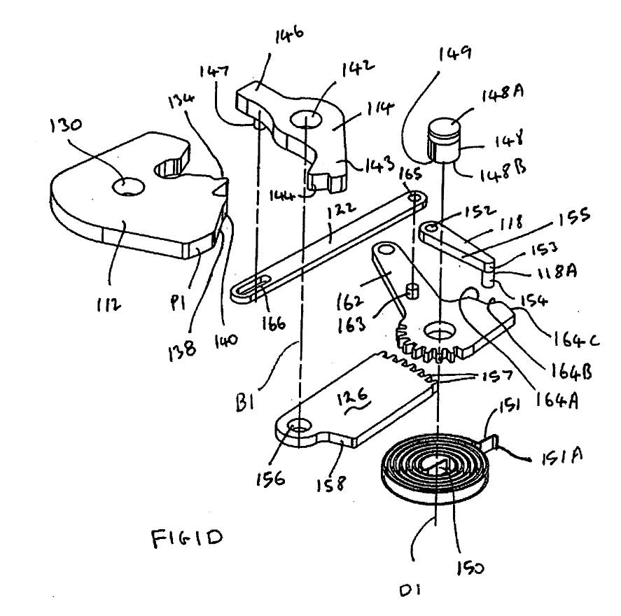

FIGS. 2A1 to 2E show a latch assembly 210 in which components which fulfill substantially the same function as those of the latch assembly 110 are labelled 100 greater.

A claw 212, a pawl 214, a link 222, a gear 226 and a spring 216 are identical to the equivalent components in the latch assembly 110. The drive plate 220 includes a lug 272 instead of the release arm 162. The lug 272 simply provides support for a release pin 263, which operates in a manner similar to the release arm pin 163. Furthermore, the drive plate 220 does not include a camming region equivalent to the camming region 164.

Gear teeth 261, a boss 267 and a spring abutment 268 are identical to their equivalent components in the latch assembly 110.

Because the drive plate 220 does not include a camming region equivalent to the camming region 164, it is not necessary for the detent 218 to include a camming abutment equivalent to the camming abutment 153. Thus, the detent 218 is generally elongate and includes a hole 252 to pivotally mount the detent 218 about an axis E2 relative to a latch body 224. A spring abutment 254 is provided on one end of the detent 218 and operates in a manner similar to the spring abutment 154 of the latch assembly 110. The detent 218 includes a further arm 273 having a hole 274 connected to a manually operable element M2. Actuation of the manually operable element M2 causes the detent 218 to rotate clockwise about the axis E2, thereby releasing a radially outer end 251 of the spring 216, which then acts to release the latch.

The relative strength of the spiral spring 116 and the speed at which the manually operable element M1 is operated affects the amount of assistance the spiral spring 116 gives to releasing the latch. Thus, in one embodiment, the spiral spring 116 could be sufficiently strong to release the latch. Under these circumstances, the user is only required to actuate the manually operable element M1 to such an extent that the detent 118 releases the spiral spring 116. Once the spiral spring 116 has been released, the spiral spring 116 itself operates to release the latch. Alternatively, the spiral spring 116 alone may not be capable of disengaging the pawl tooth 144 from the closed abutment 134, of the claw 112. Under these circumstances, the user is required to actuate the manually operable element M1 to enable the detent 118 to release the spiral spring 116 and then continue to operate the manually operable element M1 until the latch reaches the position shown in Figure “1B”. Nevertheless, the spiral spring 116 is assisting the user to disengage the pawl tooth 144 from the closed abutment 134 of the claw 112.

Turning to the second embodiment, the spring 216 must be capable of disengaging a pawl tooth 244 from a closed abutment 234 of the claw 212 alone, since in the second embodiment, the manually operable element M2 simply operates to release the spiral spring 116 and cannot be operated to drive the pawl 214. Thus, the concept of the spring 216 assisting release of the latch includes the concept of the spring 216 being powerful enough to release the latch alone, and the phrase “assist” used in this context should be construed accordingly.

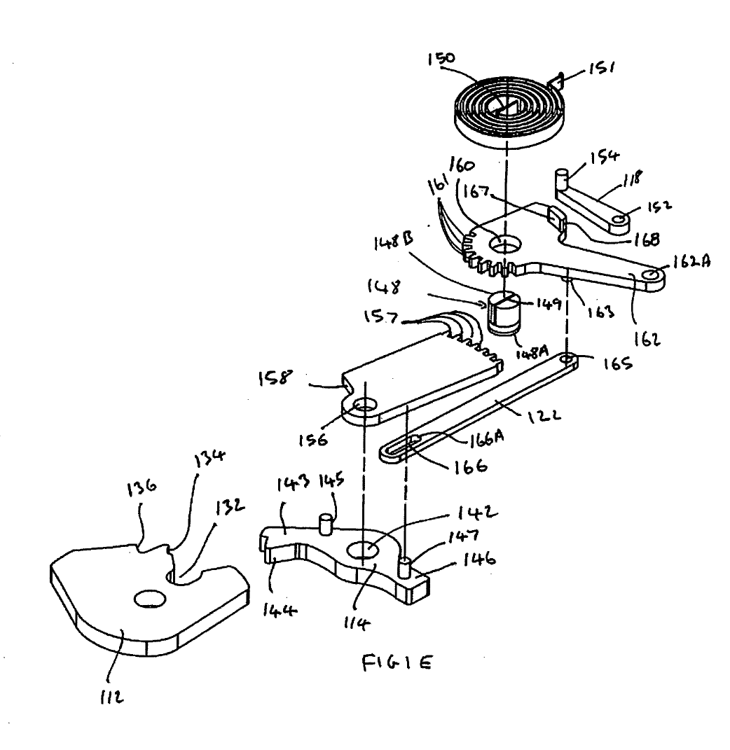

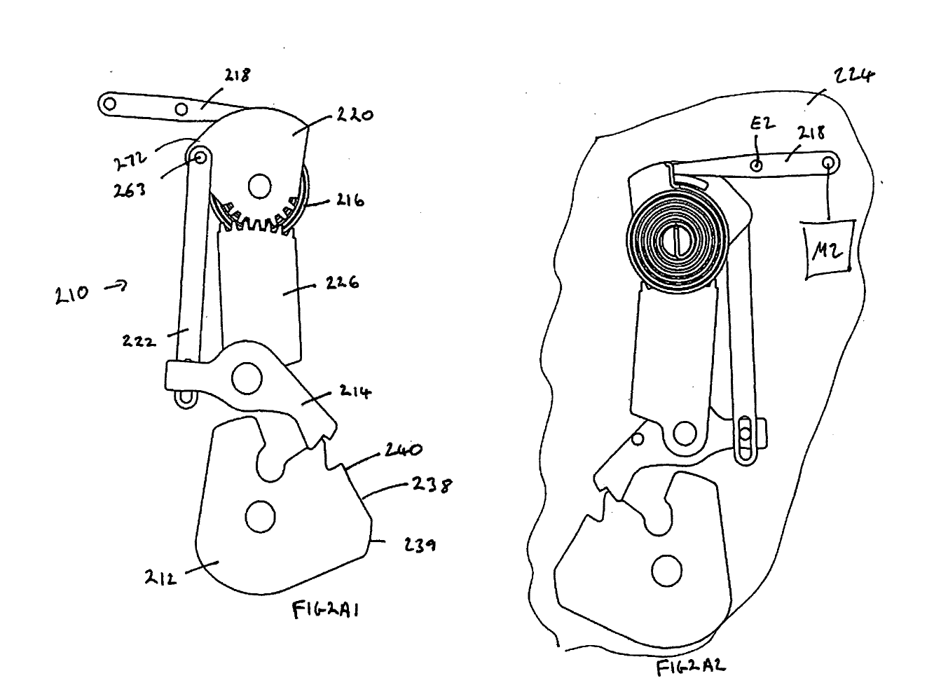

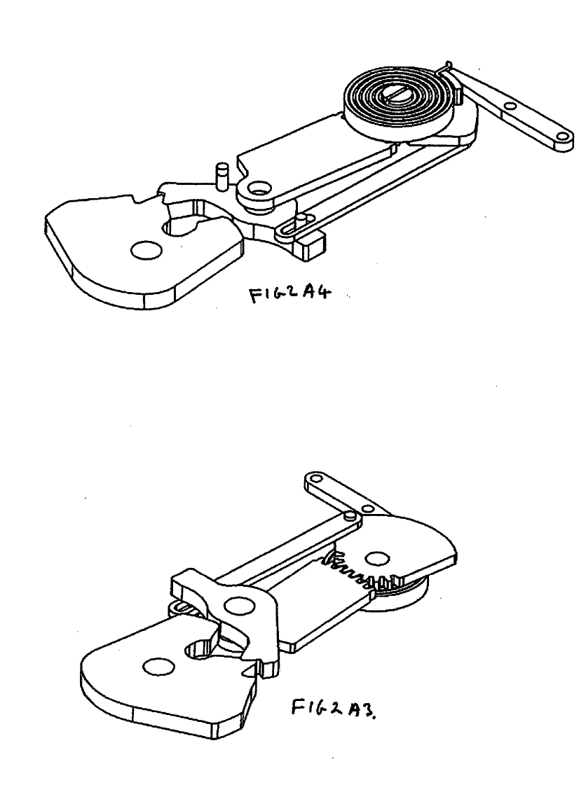

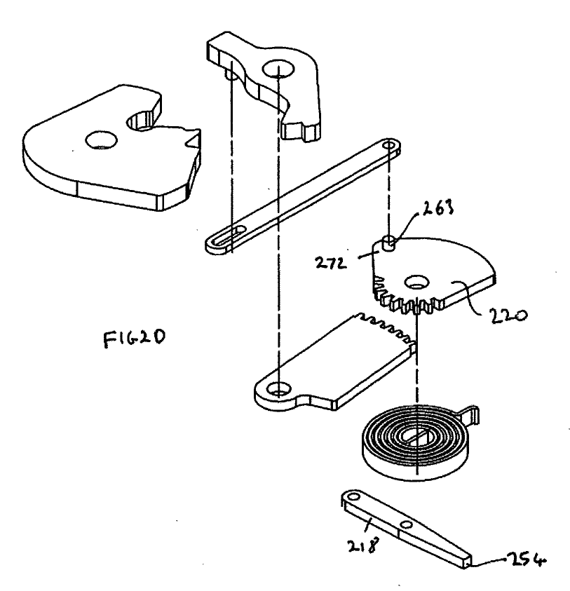

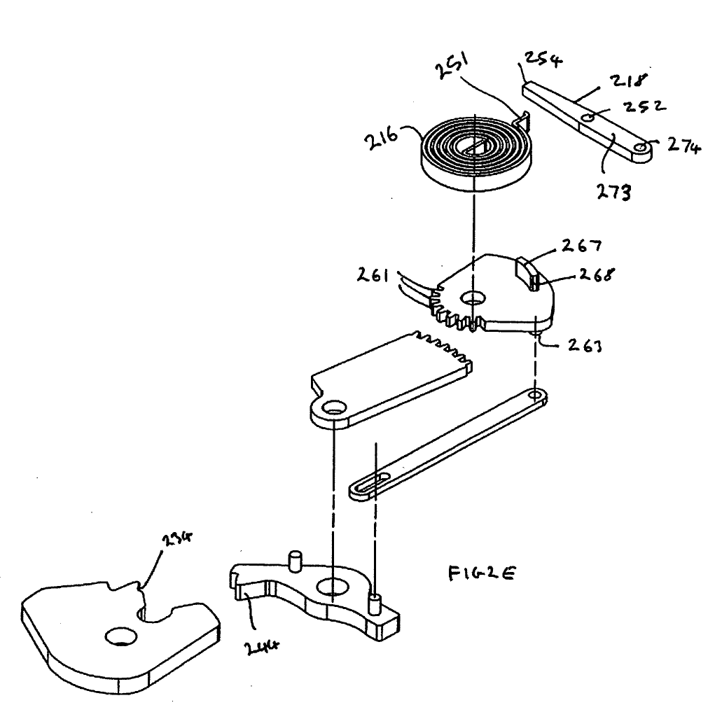

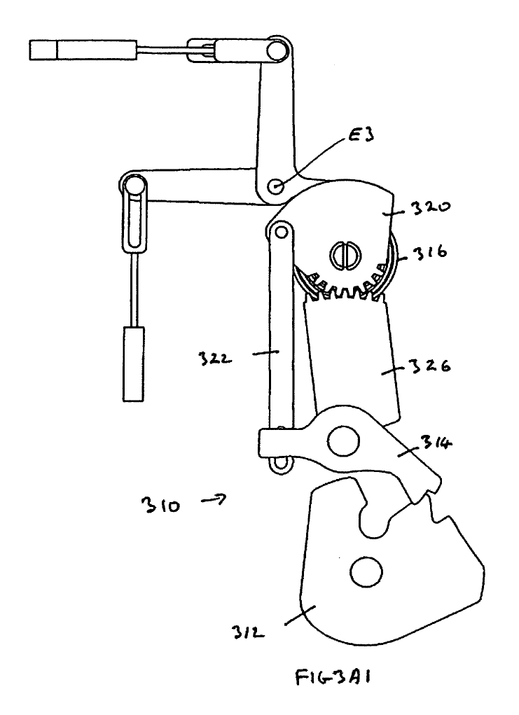

FIGS. 3A1 to 3E show a third embodiment of a latch assembly 310 in which components which fulfill substantially the same function as those of the latch assembly 210 are labelled 100 greater.

A claw 312, a pawl 314, a link 322, a gear 326, a spring 316 and a drive plate 320 are identical to the equivalent components in the latch assembly 210. A detent 318 is similar in principal to the detent 218, though is slightly narrower. The detent 318 includes a spring abutment 354, a pivot hole 352, a further arm 373 and a hole 374. A pin 375 passes through a slotted end 376A of an inside release cable 376, a slotted end 377A of an outside release cable 377 and the hole 374 to couple the release cables to the detent 318. The inside release cable 376 is a bowden cable and is connected to an inside release handle M3 (shown schematically on FIG. 3A3). Similarly, the outside release cable 377 is a bowden type cable and is connected to the outside release handle M3.

When the latch is in the unlocked condition, operation of either the inside release handle M3 or the outside release handle M3 will cause the detent 318 to release the spring 316, thereby releasing the latch. The spring 316 can be rewound in a manner similar to the first and second embodiments.

The latch assembly 310 further includes a lock lever 378 pivotable about an axis E3 and having a first arm 379 with a spring abutment 379A and a second arm 380 with a hole 380A. A pin 381 passes through a hole 382A of an inside lock cable 382 and through a slotted hole 383A of an outside lock cable 383 to secure the cables to the lock lever 378. The inside lock cable 382 is a bowden cable and one end is connected to a sill button or the like. The outside lock cable 383 is also a bowden type cable and one end is connected to a key barrel or the like. In a further embodiment, the lock lever 378 can additionally, or alternatively, be operated by a power actuator, such as an electric motor. As shown in FIG. 3A2, the spring abutment 354 of the detent 318 and the spring abutment 379A of the lock lever 378 lie adjacent to one another and both nominally abut a radially outer end 351 of the spring 316.

As shown in FIG. 3A2, the latch is in a locked condition. If either the inside or outside release handles M3 are operated to rotate the detent 318 in a clockwise direction about the axis E3, the spring abutment 379A of the lock lever 378 will remain facing and in engagement with a radially outer end 351 of the spring 316, thereby preventing the radially outer end 351 of the spring 316 from being released and hence preventing the latch from unlatching. Thus, the lock lever blocks the first drive path by acting on the spring 316.

To unlock the latch, the inside lock cable 382 or the outside lock cable 383 must be operated to rotate the lock lever 378 about the axis E3 in a clockwise direction when viewing FIG. 3A2, such that the spring abutment 379A is moved generally upwardly such that it no longer faces the radially outer end 351 of the spring 316 and hence cannot prevent release of the radially outer end 315 of the spring 316 when the detent 318 is subsequently rotated clockwise. An over-center spring (not shown) is provided on the lock lever 378, which biases the lock lever 378 either to the locked or the unlocked position to give a definite locked and unlocked position and to give a positive feel to the sill button or key barrel when operated.

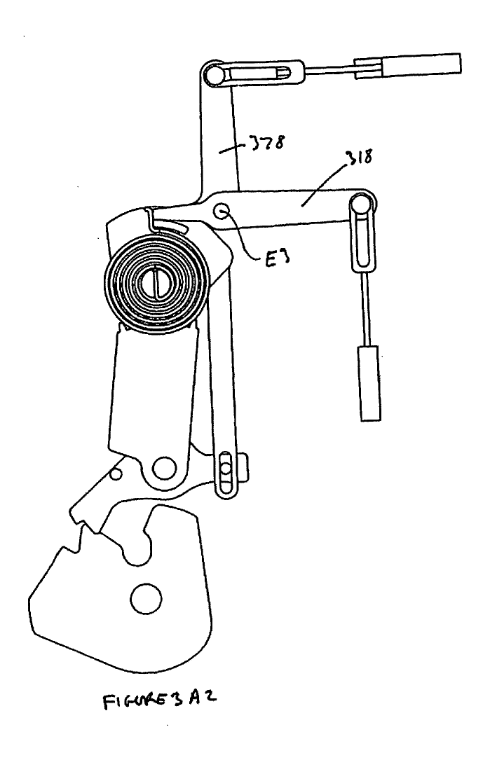

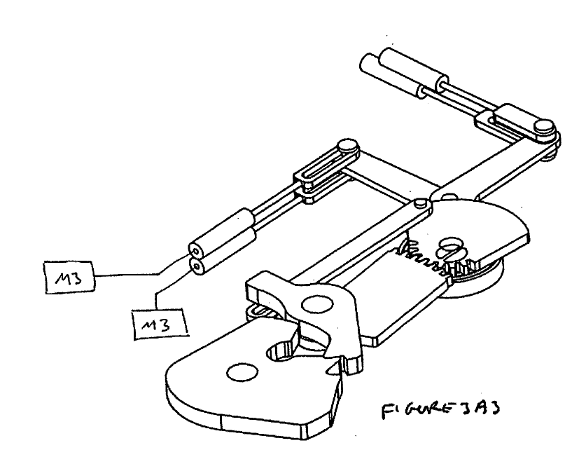

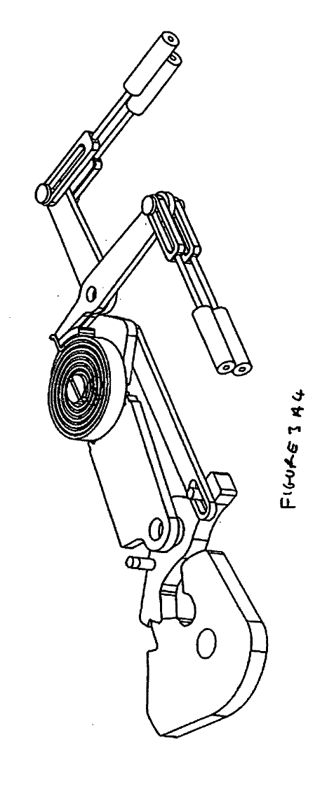

With reference to FIG. 4A1 to 4C4, a fourth embodiment of a latch assembly 410 is shown in which components which fulfill substantially the same function as those of the latch assembly 210 are labelled 200 greater.

A claw 412, a pawl 414, a link 422, a gear 426, and a spring 416 are all identical to the equivalent components in the latch assembly 210. A detent 418 is substantially identical to the detent 218, the only difference being that an axis E4 has been moved to provide a greater lever ratio for a manually operable element M4.

The drive plate 420 is similar to the drive plate 220, except that it further includes a lug 484 having a hole 485. The hole 485 is connected to a further manually actuable element M4′.

With correct functioning of the device, the user operates the manually actuable element M4 to release the latch in a manner similar to operation of the manually operable element M2 of the latch assembly 210.

However, in the event that the spring 416 breaks, operation of the manually operable element M4 will not release the latch. Under these circumstances, the further manually operable element M4′ is typically provided inside the vehicle such that under emergency situations, the manually operable element M4′ can be operated to release the latch. When the manually operable element M4′ is used when the spring 416 is broken, the spring 416 will provide no assistance to release the latch. Whereas, the manually operable element M4 might be an inside door handle that is normally used to release the latch, the manually operable element M4′ is distinct from the manually operable element M4 and would never be used to open the door under normal circumstances. Indeed, the spring 416 would be designed to last the life of the vehicle and would not be expected to fail. Thus, the manually operable element M4′ would rarely, if ever, be used.

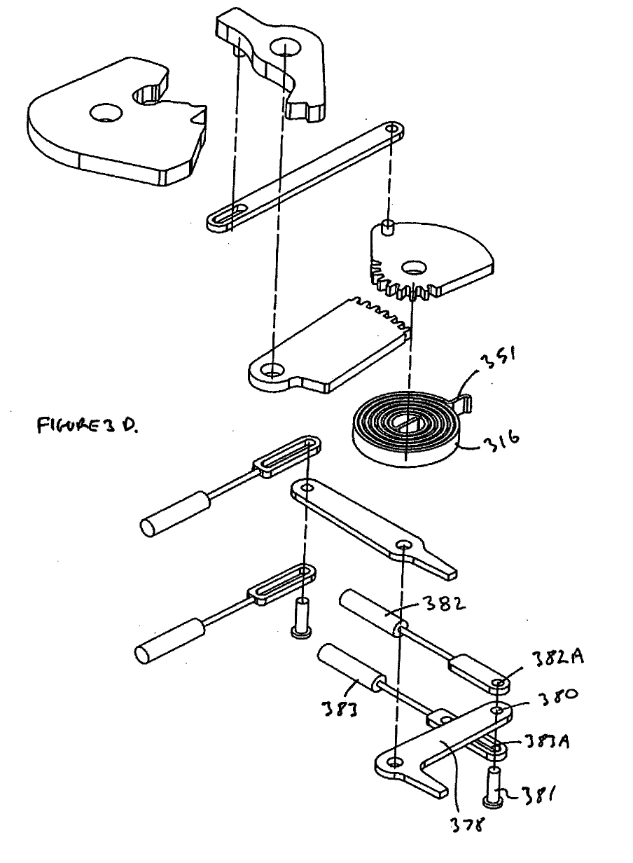

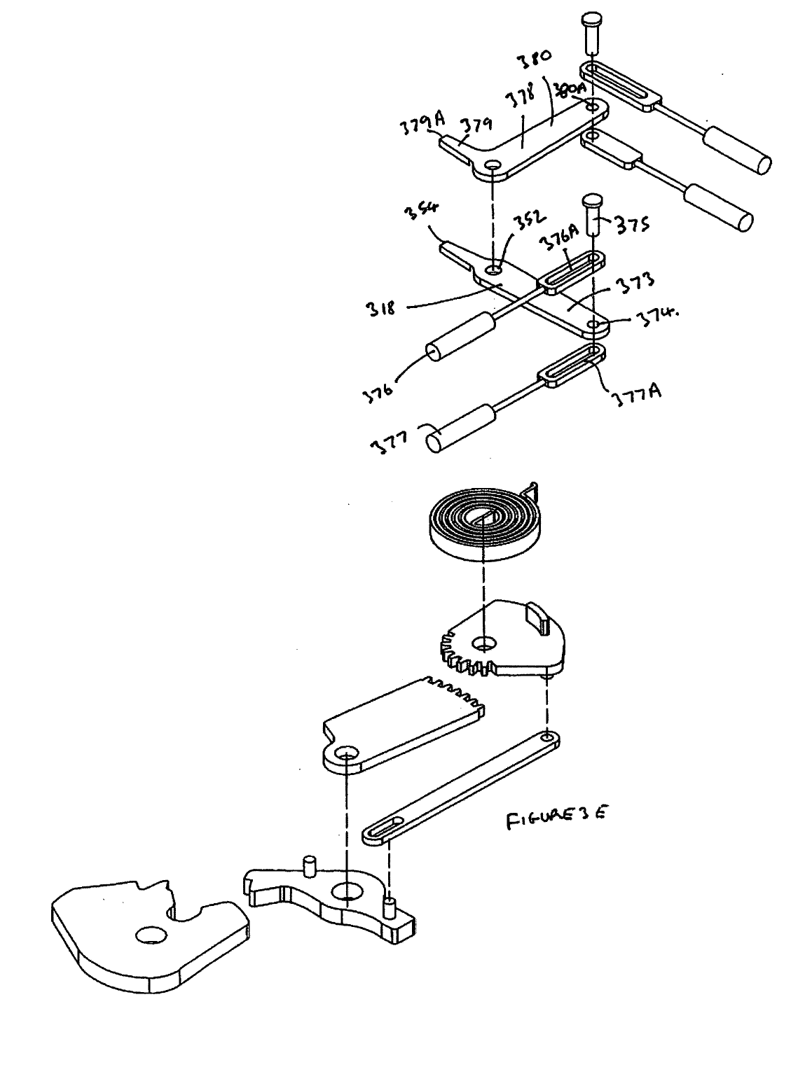

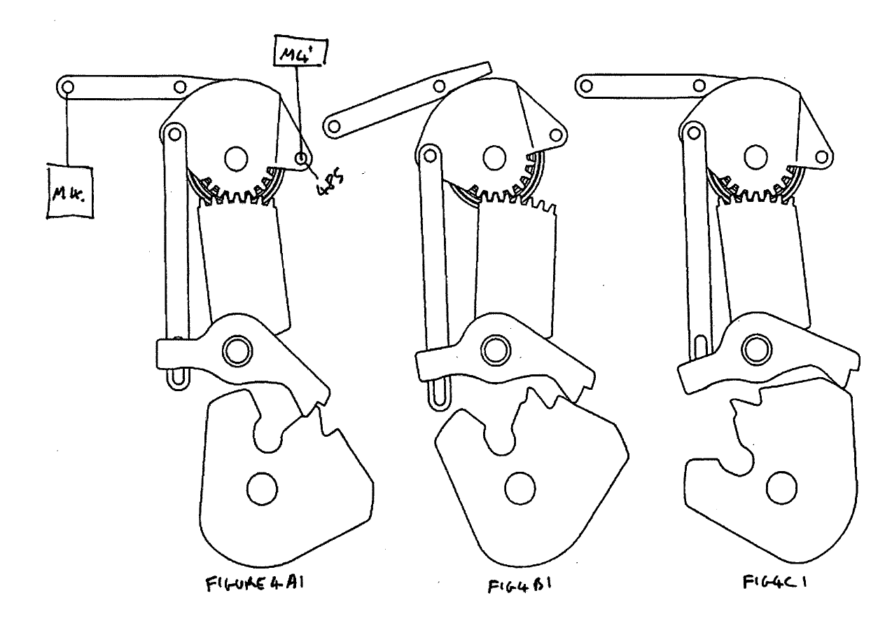

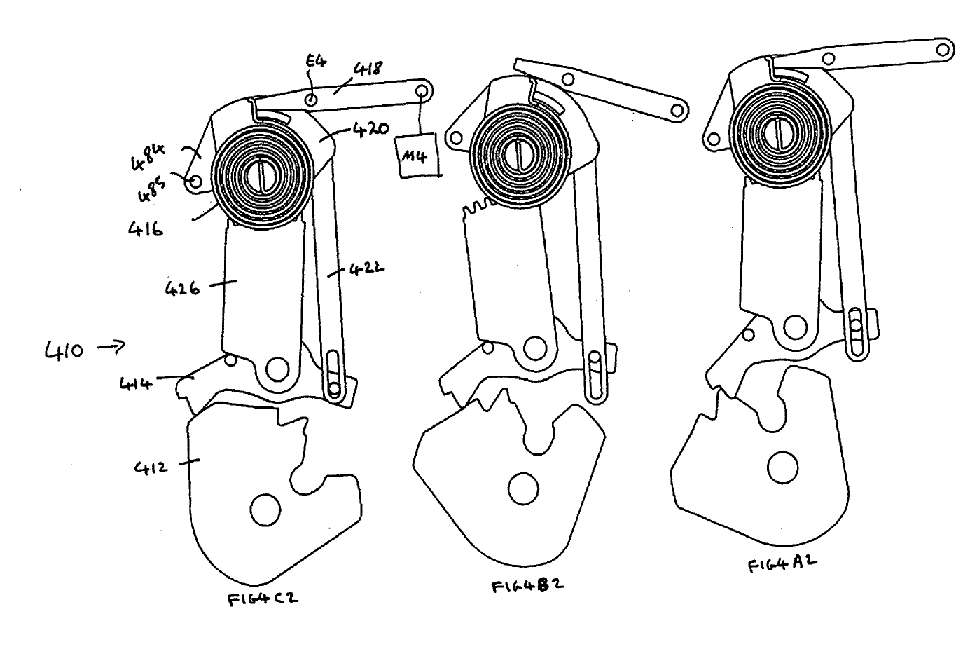

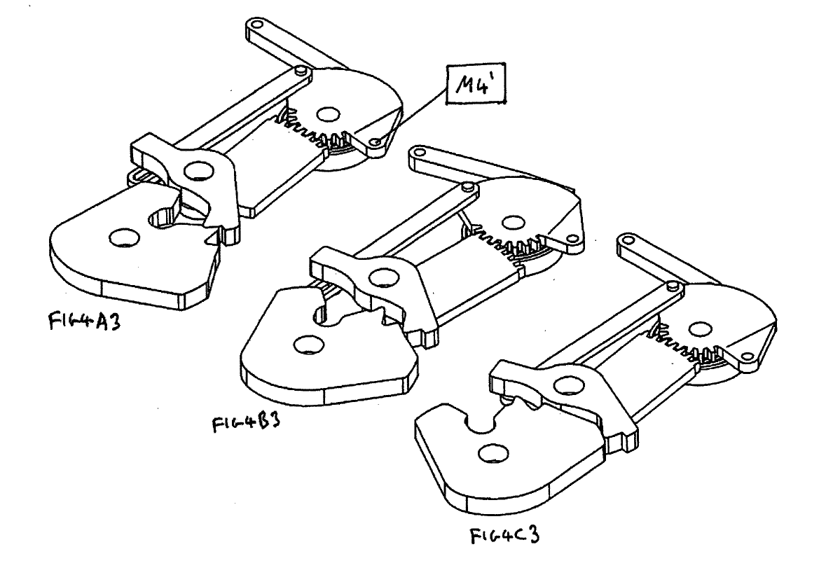

With reference to FIGS. 5A1 to 5E, a fifth embodiment of a latch assembly 510 is shown in which components which fulfill substantially the same function as those shown in the latch assembly 210 are labelled 300 greater.

A claw 512, a pawl 514, a gear 526, a link 522, a drive plate 520 and a spring 516 are identical to the equivalent components in the latch assembly 210. In this case, a detent 518 is power driven rather than manually driven. Thus, the detent 518 includes a spring abutment 554 and is pivoted about an axis E5. However, the detent 518 includes a gear quadrant 586 having teeth which mesh with a pinion 587 driven by a power actuator in the form of an electric motor 588.

Upon receipt of an opening signal, a control system (not shown) is operated to supply power to the electric motor 588 to drive the gear quadrant 586 to disengage the spring abutment 554 from a radially outer end 551 of the spring 516 to release the latch. Once the latch has been opened and subsequently closed, a sensor (typically a micro switch or the like) will detect the closed position of the latch and the control system will then drive the electric motor 588 to return the spring abutment 554 to a position whereby it engages the radially outer end 551 of the spring 516 to retain it in the position shown in FIG. 5A2, ready for a subsequent release operation of the latch.

In a modified design, when the electric motor 588 is operated to release the latch, it could additionally compress or otherwise store energy in a return spring (not shown). Once power for the electric motor 588 is stopped, the return spring would act to re-engage a pawl tooth with the claw 512 upon closing of the door. This arrangement would not require a micro switch or the like, though it would require a more powerful motor since additional force would be required to act on the return spring. In an alternative design, the electric motor 588 could be connected to the pinion 587 by a centrifugal clutch, and the gear quadrant 586 could be biased in a counter-clockwise direction (when viewing FIG. 5A2) by a spring (not shown, but similar in principle to the spring 171). Under these circumstances, the centrifugal clutch would couple the electric motor 588 to the pinion 587 to disengage the spring abutment 554 from the radially outer end 551 of the spring 516. Once this has occurred, power to the electric motor 588 is stopped. The spring 516 then biases the detent 518 in a manner similar to that in which the spring 171 biases the detent 181. In this manner, it is no longer required to reverse drive the electric motor 588 upon closing of the latch. In a further alternative design, the electric motor 588 could be replaced by a solenoid that acts to drive the detent 518, and for example, an arm (not shown) could replace the gear quadrant 586 with the solenoid acting on an end on the arm. When a solenoid is used, the control system as mentioned above in respect to the electric motor 588 could be used, or alternatively a return spring (as mentioned above) could be used.

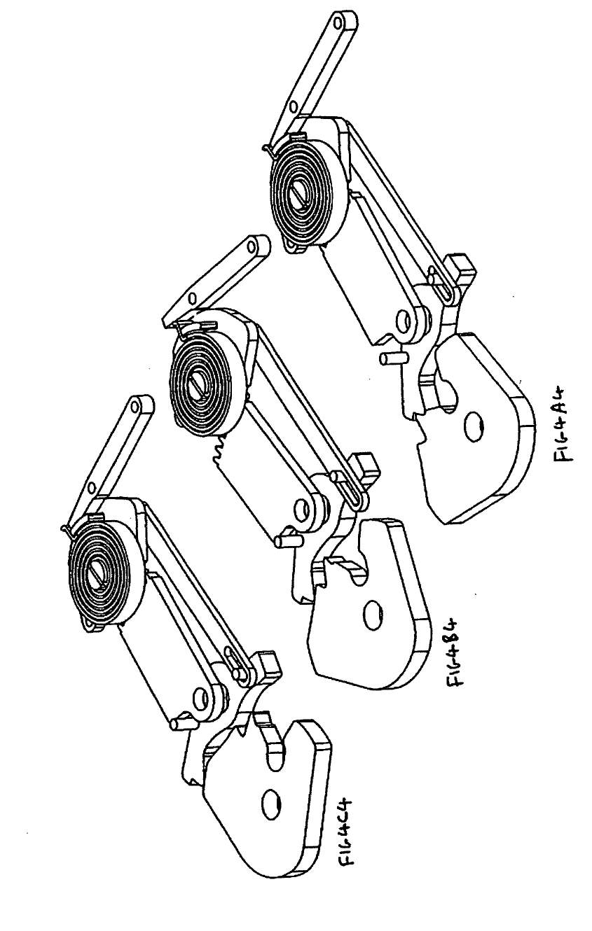

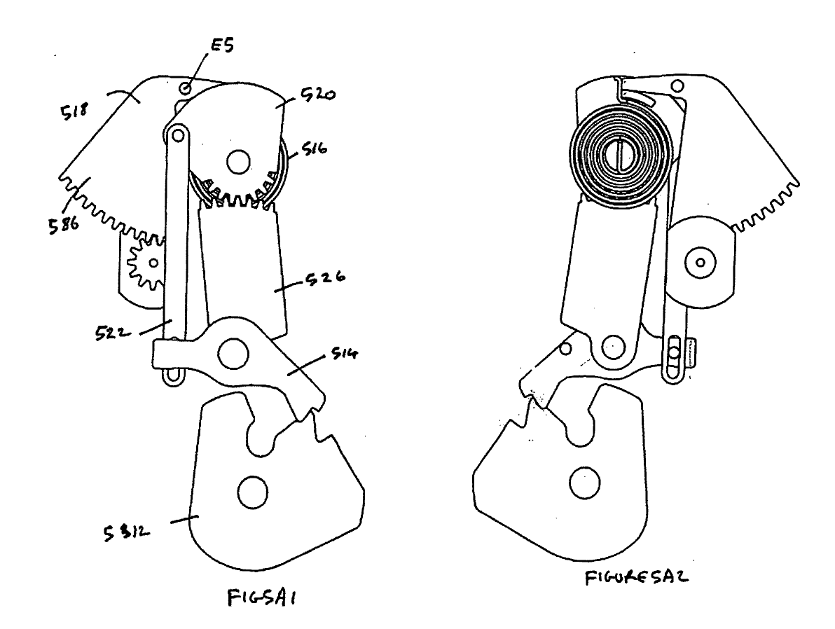

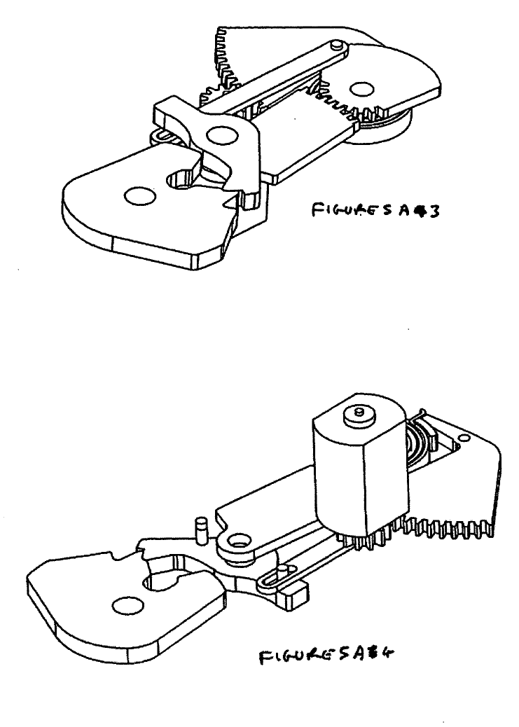

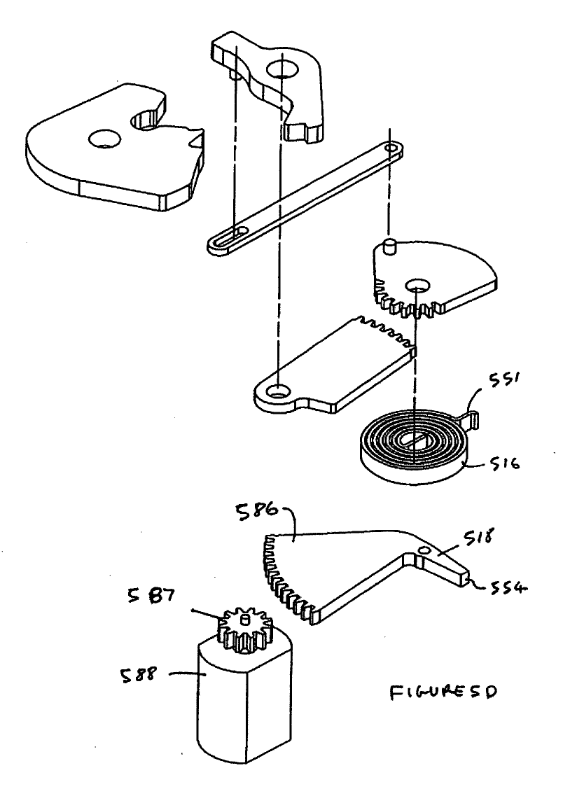

With reference to FIGS. 6A1 and 6D, there is shown a sixth embodiment of a latch assembly 610 in which components which fulfill substantially the same function as those shown in the latch assembly 510 are labelled 100 greater.

A claw 612, a pawl 614, a gear 626, a link 622, a drive plate 620, a spring 616, a motor 688 and a pinion 687 are identical to equivalent components of the latch assembly 510. FIGS. 6D, 5D and 2D show that a detent 618 is a hybrid version of the detents 218 and 518. Thus, the detent 618 includes a gear quadrant 686 similar to the gear quadrant 586, and the detent 618 further includes an arm portion 673 having a hole 674 operable by a manually operable element M6 in a manner similar to the arm 273, the hole 274 and the manually operable element M2. Thus, latch assembly 610 can either be manually released or can be power released.

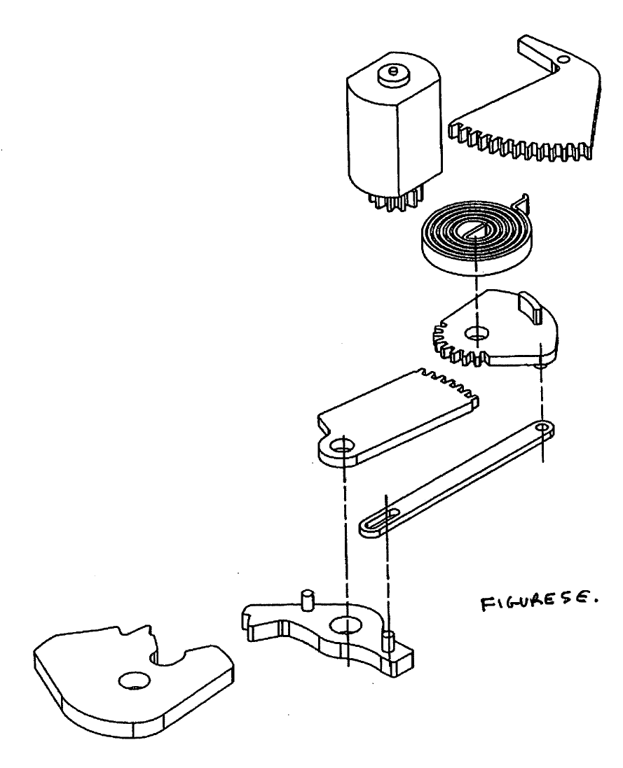

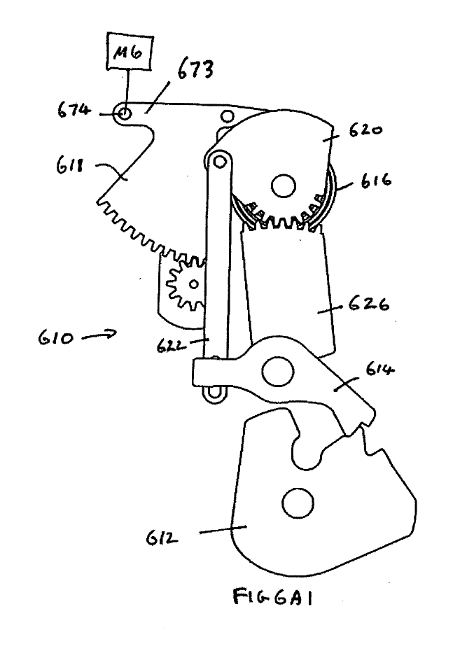

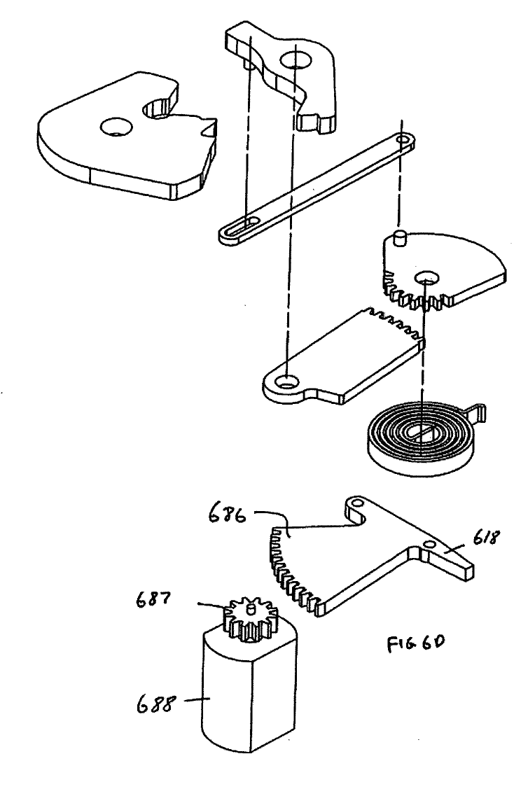

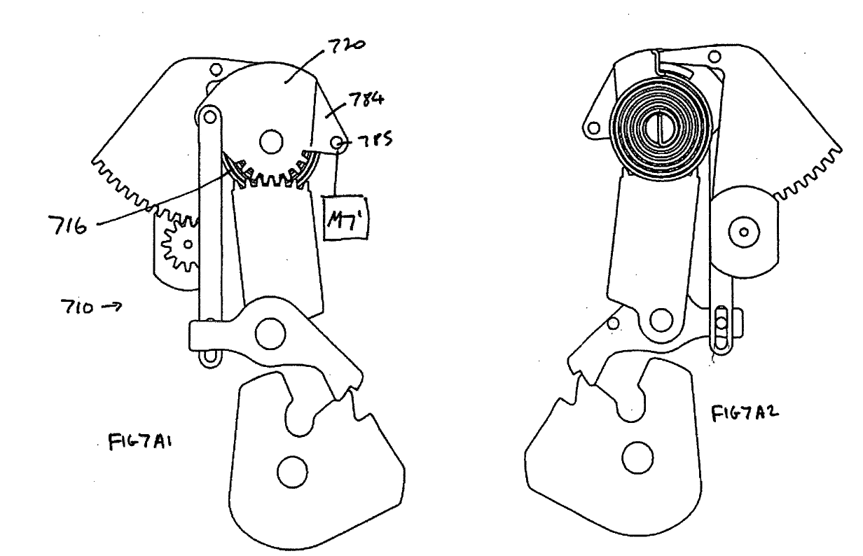

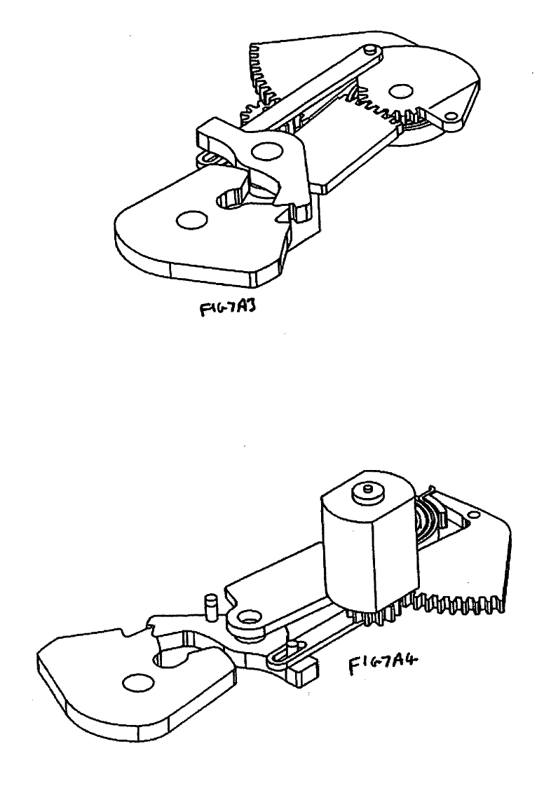

FIG. 7A1 shows a latch assembly 710 in which components which fulfill substantially the same function as those shown in the latch assembly 510 are labelled 200 greater.

The only difference between the latch assembly 710 and the latch assembly 510 is that a drive plate 720 of the latch assembly 710 includes a lug 784 and a hole 785. Thus, the drive plate 720 is identical to the drive plate 420. The hole 785 is connected to a manually actuable element M7′, which can be used in emergency circumstances when a spring 716 breaks to release the latch in a manner similar to operation of the manually operable element M4′.

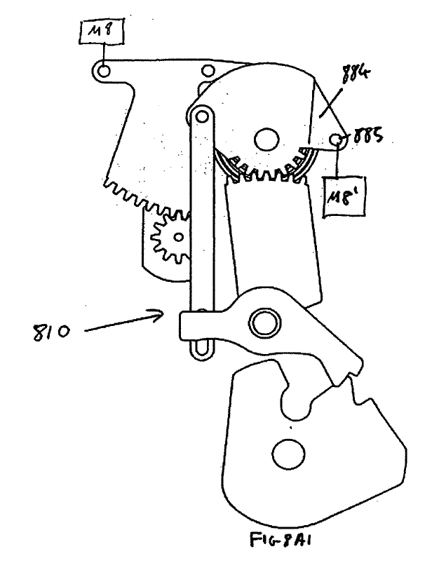

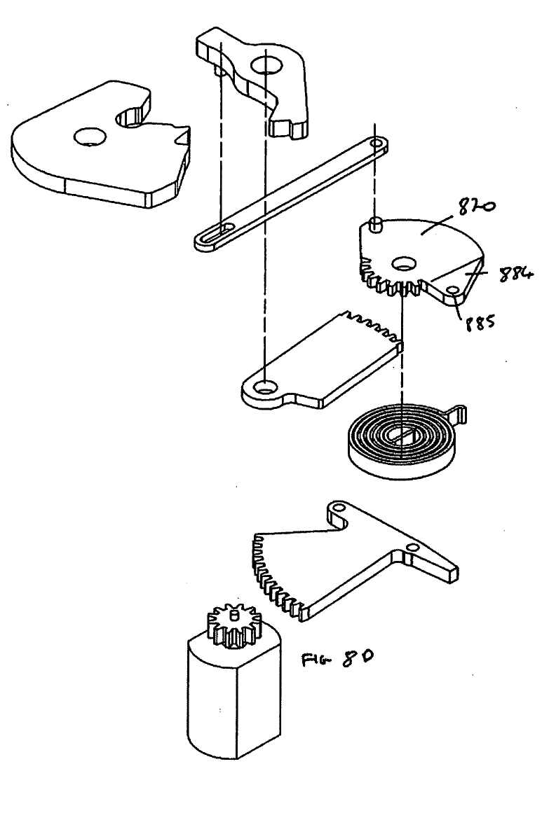

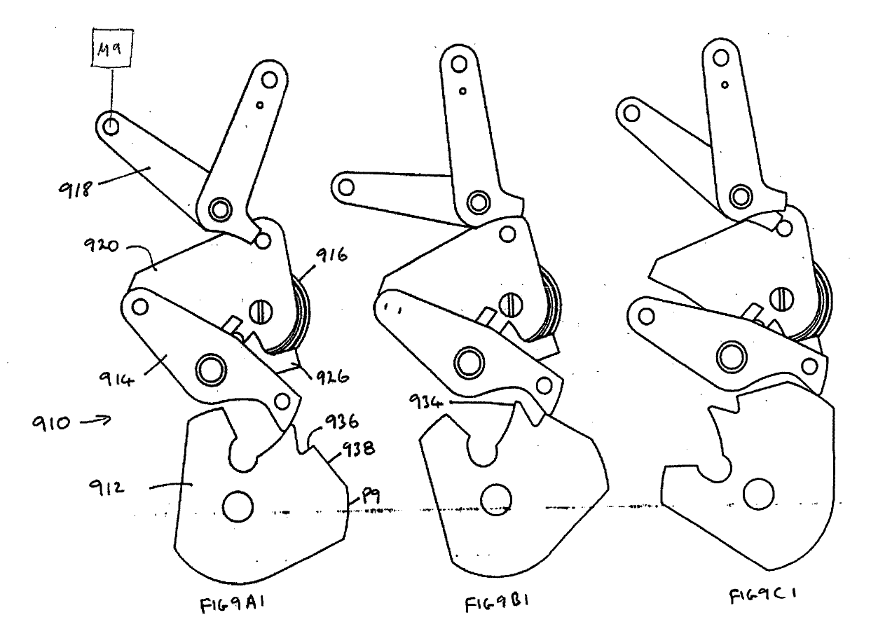

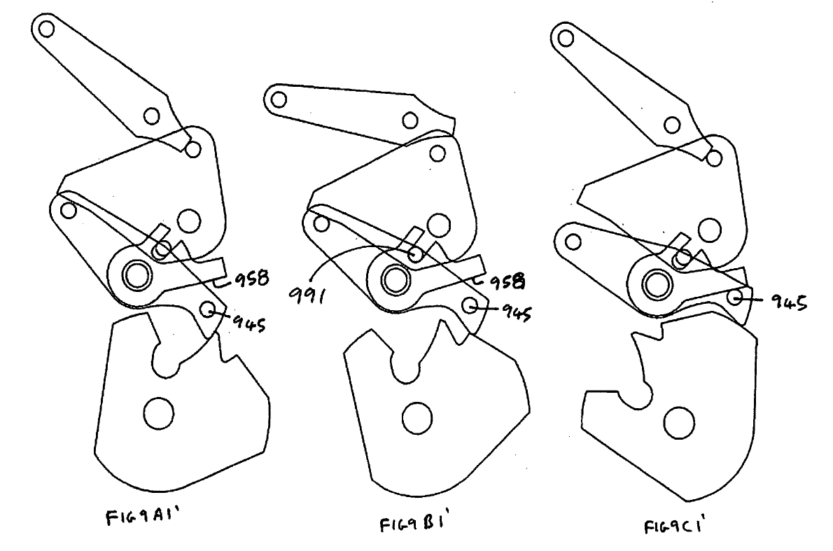

FIGS. 8A1 and 8D show a latch assembly 810 in which components that fulfill substantially the same function as those components in the latch assembly 610 are labelled 200 greater.

In this case, the only difference between the latch assembly 810 and the latch assembly 610 is that a drive plate 820 of the latch assembly 810 includes a lug 884 and a hole 885 to enable the drive plate 820 to be connected to a manually operable element M8′. Thus, the drive plate 820 is identical to the drive plates 720 and 420, and the manually operable element M8′ is operated under emergency situations in a manner similar to operation of the manually operable element M4′ and the manually operable element M7′.

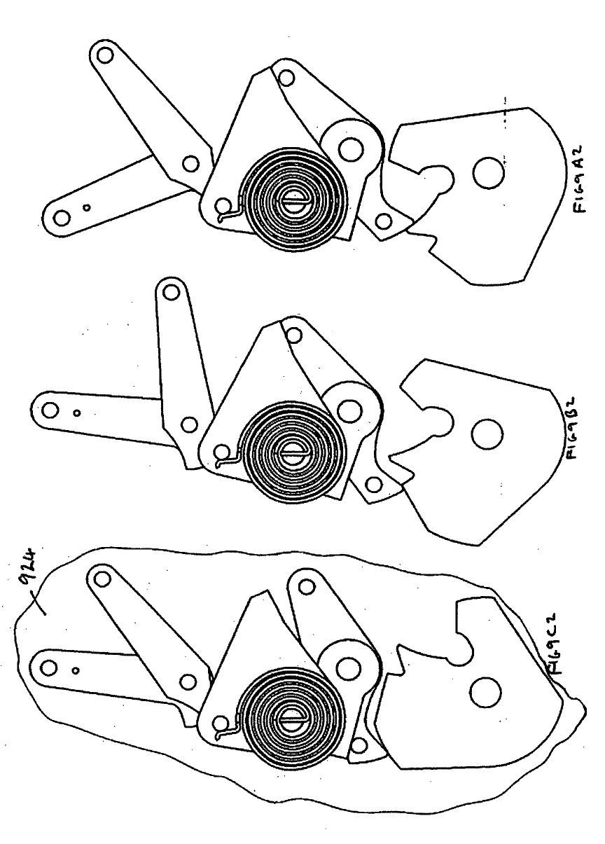

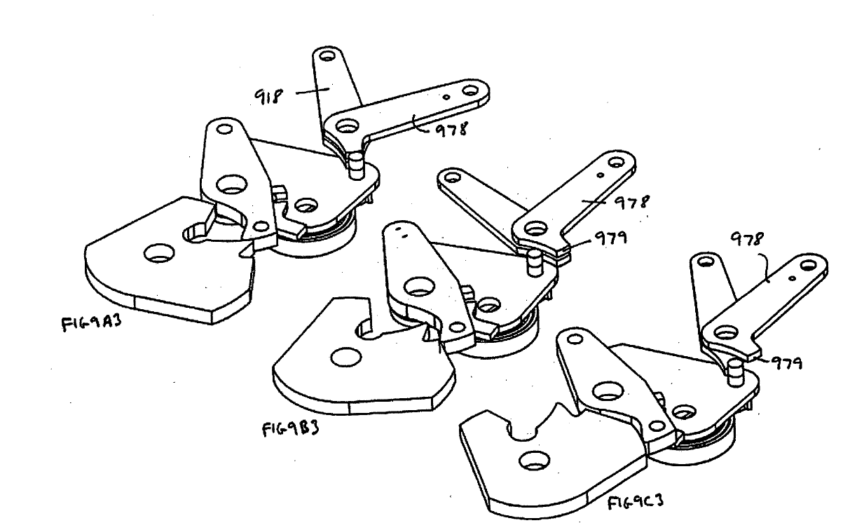

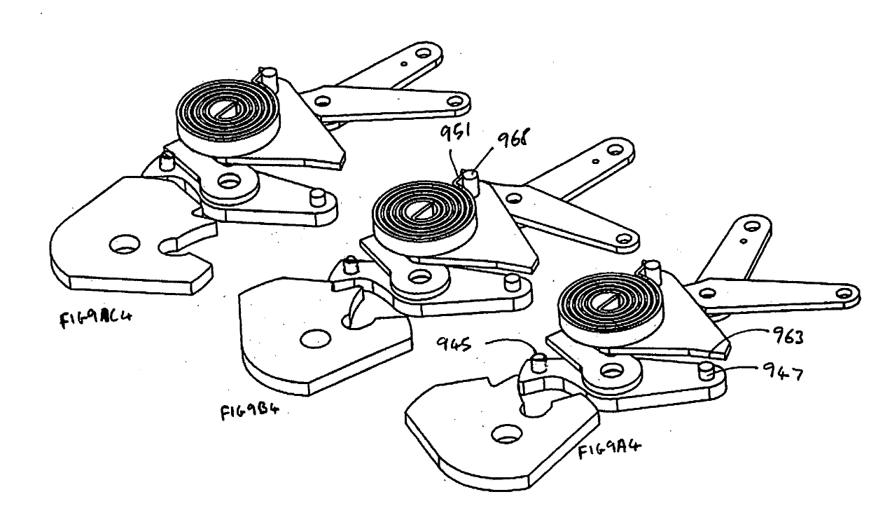

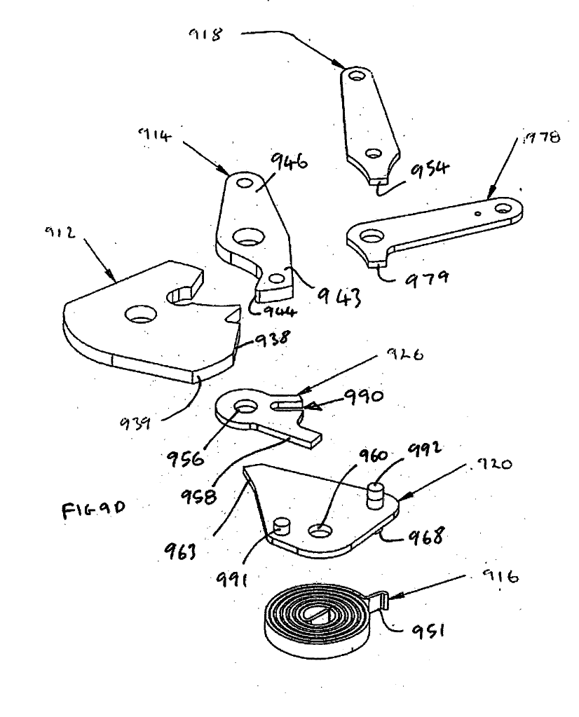

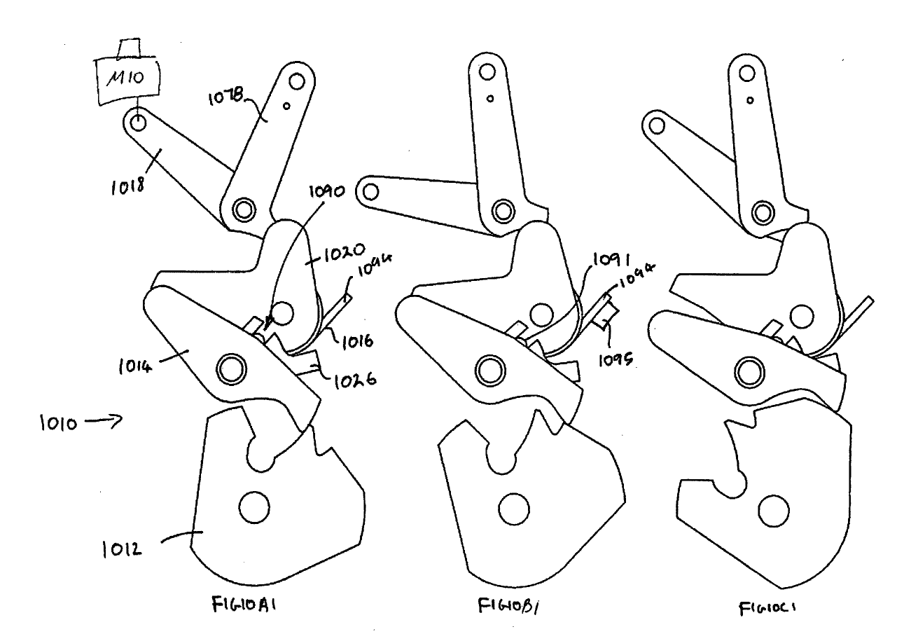

FIGS. 9A1 to 9D show a ninth embodiment of a latch assembly 910 in which components that fulfill substantially the same function as those of the latch assembly 210 are labelled 700 greater.

A claw 912 includes a ramp portion 938 and a portion 939 equivalent to the features 238 and 239, respectively. However, the claw 912 does not include a further portion equivalent to the feature 240.

A rewind plate 926 fulfills the same function as the gear 226. The rewind plate 926 includes a hole 956 to pivotally mount the rewind plate 926 on a pawl pivot pin. A rewind abutment 958 is provided on an edge of the rewind plate 926, which is driven by a rewind pin 945 of a pawl 914. Rather than having gear teeth, the rewind plate 926 includes a slot 990 within which sits a rewind pin 991 (best seen in FIGS. 9A1′, B1′ and C1′).

A drive plate 920 includes a hole 960 to allow the drive plate 920 to be pivotally mounted on a latch body 924. As mentioned above, the drive plate 920 includes the rewind pin 991, which fulfills the same function as the teeth 261. The latch assembly 910 does not include a link equivalent to the link 222. Instead, the drive plate 920 includes an edge 963 that bears directly on a pawl release pin 947. The drive plate 920 includes a spring abutment 968 against which a radially outer end 951 of the spring 916 bears. In this case, the spring abutment 968 is a pin projecting from the drive plate 920. A further portion 992 of the pin projects from the other side of the drive plate 920. In this case, an abutment 954 of the detent 918 engages a further portion 992 (best seen in FIGS. 9A3 and 9C3) to retain the spring 916 in its rewound condition, rather than bearing directly on the radially outer end 951 of the spring 916.

A lock lever 978 operates in a manner similar to the lock lever 378. However, the abutment 979 of the lock lever 978 engages the further portion 992, rather than acting directly on the radially outer end 951 of the spring 916 to block the first drive path. As best seen in FIG. 9A3, the lock lever 978 is in a locked position since the abutment 979 is facing the further portion 992. Even if the detent 918 were to be actuated, the abutment 979 will prevent the drive plate 920 from rotating. FIGS. 9B3 and 9C3 show the lock lever 978 in an unlocked position wherein the abutment 979 has been rotated away from the further portion 992.

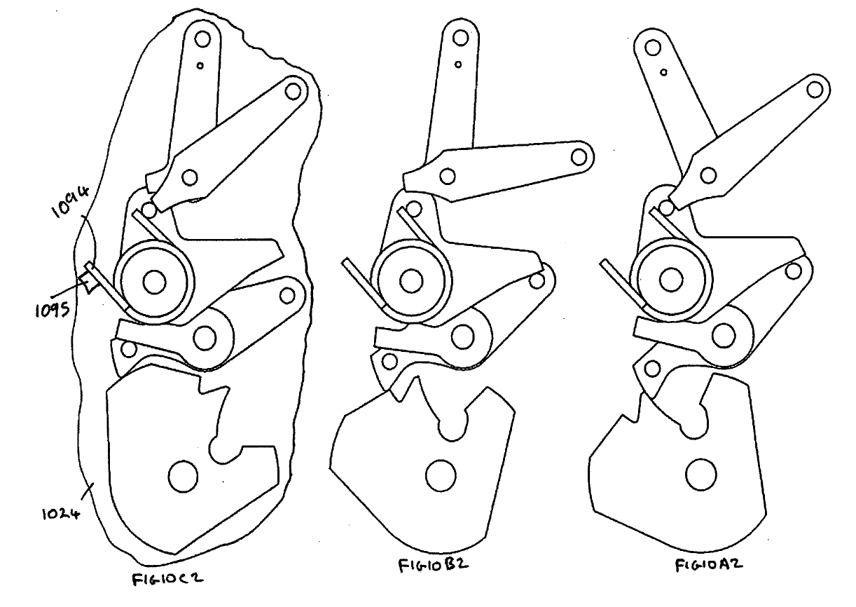

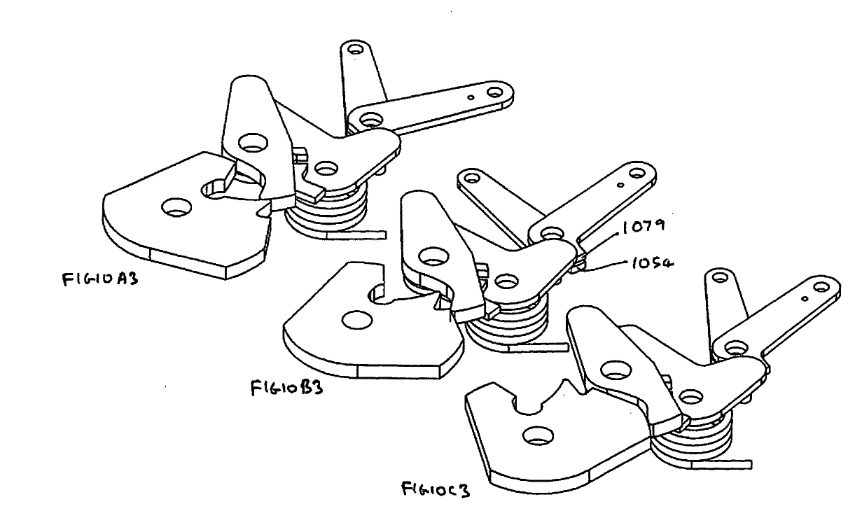

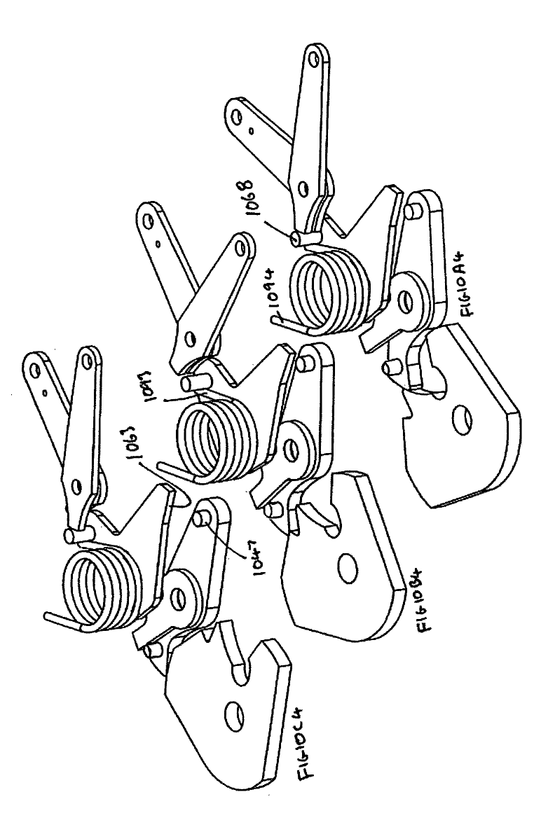

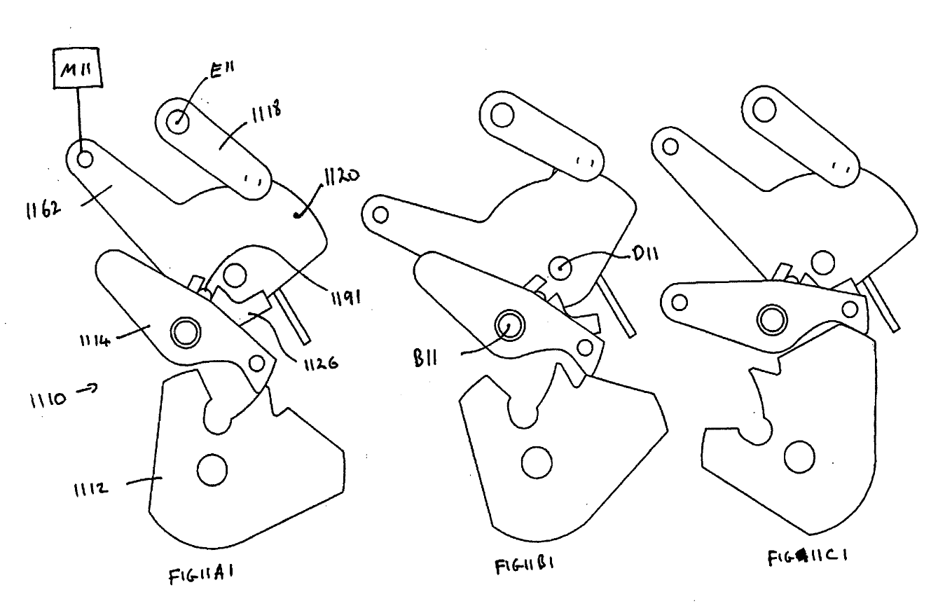

FIGS. 10A1 to 10C4 show a tenth embodiment of a latch assembly 1010 in which components which fulfill substantially the same function as those shown in the latch assembly 910 are labelled 100 greater.

A claw 1012, a pawl 1014, a detent 1018, a rewind plate 1026 and a lock lever 1078 are identical to the equivalent components in the latch assembly 910. A drive plate 1020 includes an edge 1063 which engages a pawl release pin 1047 during release of the latch. The drive plate 1020 also includes a rewind pin 1091 which is driven by a slot 1090 of the rewind plate 1026 as the spring 1016 is rewound. In this case, the drive plate 1020 includes a spring abutment pin 1068, one side of which is engaged by a spring arm 1093 and the other side of which abutments 1054 of the detent 1018 and an abutment 1079 of a lock lever 1078 can selectively engage or disengage.

In this case, the spring 1016 is a helical spring including the tangentially projecting spring arm 1093 which engages the spring abutment pin 1068, as mentioned above, and a further tangentially orientated arm 1094 which reacts against an abutment 1095 (shown schematically in FIG. 10C2) which is fixed to a latch body 1024.

The coils of the spring 1016 define a cylinder, and in a preferred embodiment, the cylinder of coils is mounted on a cylindrical boss (not shown) of the latch body 1024.

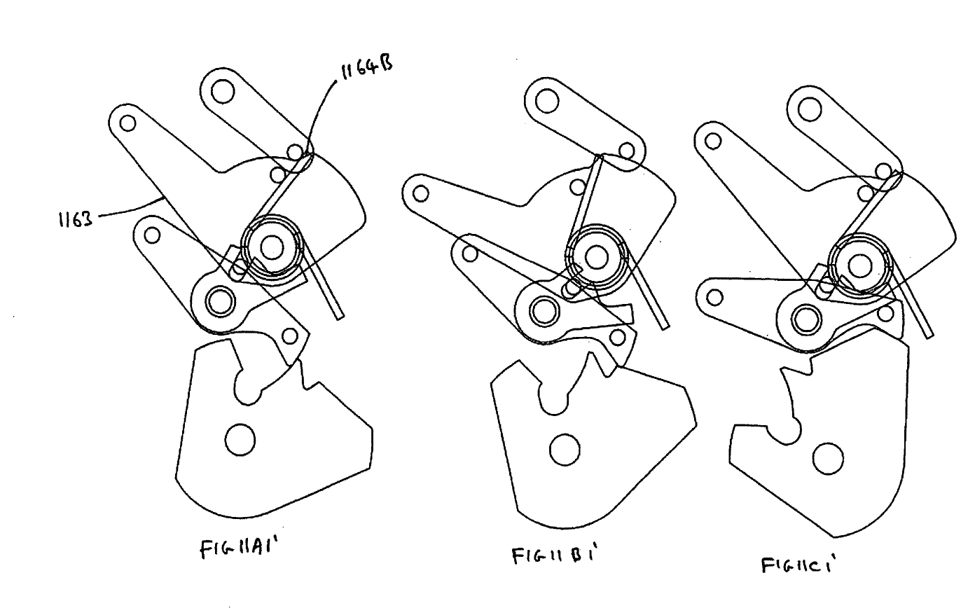

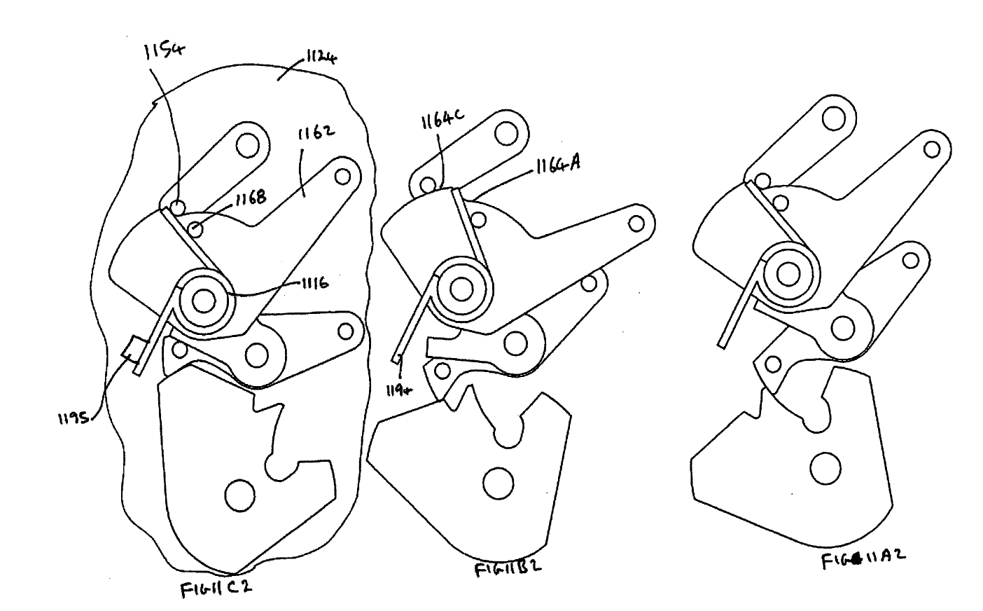

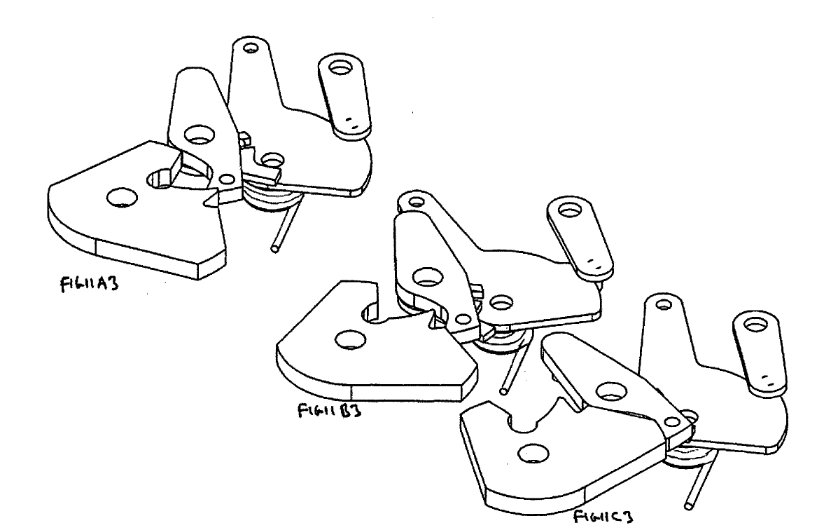

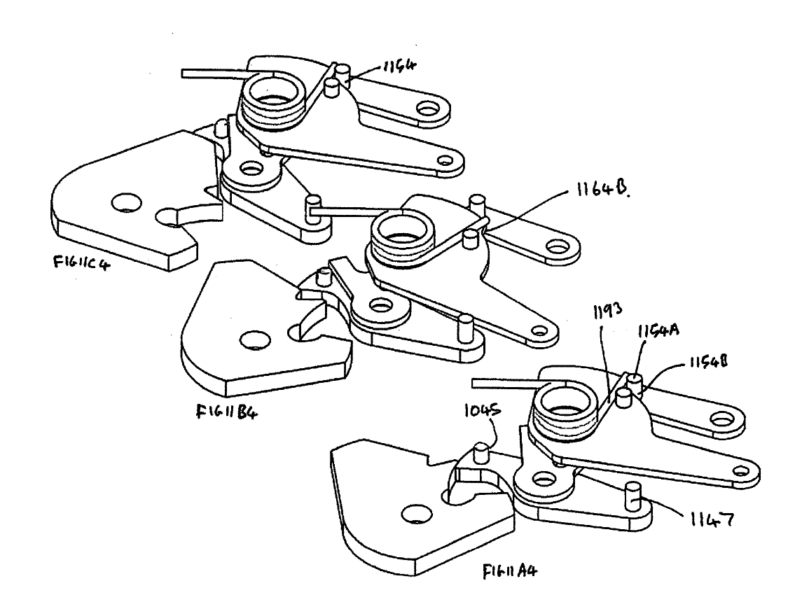

FIGS. 11A1 to 11C4 show an eleventh embodiment of a latch assembly 1110. A claw 1112, a pawl 1114 and a rewind plate 1126 are identical to and operate in a similar manner to the equivalent features of the latch assembly 1010.

A drive plate 1120 includes a rewind pin 1191 equivalent to the rewind pin 991 of the latch assembly 910. The drive plate 1120 also includes a release arm 1162, a spring abutment 1168, and a ramp portion 1164B which operate in a manner similar to the equivalent components of the latch assembly 110. A detent 1118 operates in a similar manner to the detent 118. In this case, the detent 1118 includes a spring abutment in the form of a pin 1154. One end 1154A of the pin 1154 engages a spring arm 1193, and the other end 1154B of the pin 1154 engages ramp portions 1164B, 1164A and 1164C. An arm 1194 of the spring 1116 reacts against an abutment 1195 of a latch body 1124.

The foregoing description is only exemplary of the principles of the invention. Many modifications and variations of the present invention are possible in light of the above teachings. The preferred embodiments of this invention have been disclosed, however, so that one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

1. A latch comprising:
a latch bolt having a closed position and an open position;
a pawl having an engaged position wherein the pawl retains the latch bolt in the closed position and a released position wherein the pawl allows the latch bolt to move from the closed position;
an energy storage device;
a first drive path operable to couple the energy storage device to the pawl such that the energy storage device releases energy to assist movement of the pawl from the engaged position to the released position; and
a second drive path operable to couple the latch bolt to the energy storage device such that the latch bolt restores the energy in the energy storage device during at least a part of a movement of the latch bolt from the closed position to the open position.

2. The latch as defined in claim 1 wherein the second drive path includes the pawl.

3. The latch as defined in claim 1 wherein the latch bolt includes a peripheral surface and the pawl is rotatable by the peripheral surface of the latch bolt to restore the energy in the energy storage device.

4. The latch as defined in claim 1 further including a detent, wherein the energy storage device is retained in a rest position by engagement with the detent.

5. The latch as defined in claim 4 further including a manually actuable element that operates to release the detent.

6. The latch as defined in claim 4 further including a power actuator that operates to release the detent.

7. The latch as defined in claim 1 wherein the first drive path includes a drive plate operated by the energy storage device.

8. The latch as defined in claim 7 further including a detent, wherein the drive plate includes a cam surface operable to release the detent.

9. The latch as defined in claim 7 wherein the drive plate includes a manual release lever.

10. The latch as defined in claim 7 wherein the drive plate includes a manual emergency release lever.

11. The latch as defined in claim 7 wherein the drive plate forms a part of the second drive path.

12. The latch as defined in claim 1 wherein the first drive path is blocked to lock the latch.

13. The latch as defined in claim 12 further including a lock lever that acts directly on the energy storage device to block the first drive path.

14. The latch as defined in claim 7 further including a lock lever, wherein the first drive path is blocked to lock the latch and the lock lever acts on the drive plate to block the first drive path.
